(19) United States
(12) Patent Application Publication
(10) Pub. No.: US 2023/0064816 A1
(43) Pub. Date: Mar. 2, 2023

(54) AUTOMATED COGNITIVE LOAD-BASED TASK THROTTLING

(71) Applicant: Yohana LLC, Palo Alto, CA (US)

(72) Inventors: Yoky Matsuoka, Los Altos Hills, CA (US); Nitin Viswanathan, San Francisco, CA (US); Gwendolyn W. van der Linden, Redwood City, CA (US); Malia Beaulieu, San Jose, CA (US); Lingyun Liu, Sunnyvale, CA (US); Benjamin Deming, Campbell, CA (US); Sean Paterson, Mountain View, CA (US)

(21) Appl. No.: 17/823,662

(22) Filed: Aug. 31, 2022

Related U.S. Application Data
(60) Provisional application No. 63/238,807, filed on Aug. 31, 2021.

(51) Int. Cl. G06F 9/48; G06F 9/50; G06F 40/40

(52) U.S. Cl. CPC G06F 9/4881; G06F 9/505; G06F 40/40

(57) ABSTRACT

Systems and methods for automatically throttling active tasks based on the cognitive load of members and assigned representatives are provided. A system receives, in real-time, a set of messages between a member and a representative as the set of messages are being exchanged. The system, based on these messages, automatically detects an indication of a change in the member's cognitive load and identifies the cognitive load based on the tasks being performed for the member, the presentation of these tasks, and the set of messages. If the member's cognitive load exceeds a threshold, the system dynamically selects one or more active tasks for migration to a suspended state. The remaining active tasks are performed for the benefit of the member.

### CROSS-REFERENCE TO RELATED APPLICATIONS

The present patent application claims the priority benefit of U.S. provisional patent application No. 63/238,807 filed Aug. 31, 2021, the disclosures of which are incorporated by reference herein.

### FIELD

The present disclosure relates to systems and methods for automatically throttling active tasks based on the cognitive load of members and assigned representatives. In one example, the systems and methods described herein may be used to automatically re-prioritize tasks based on changes to a member's and/or representative's cognitive load. Further, the systems and methods described herein may be used to provide automated coordination for the performance of these tasks among other representatives should an assigned representative's cognitive load exceed a threshold level.

### SUMMARY

Disclosed embodiments may provide a framework to automatically identify and recommend tasks to a member of a task facilitation service in order to reduce the member's cognitive load. According to some embodiments, a computer-implemented method is provided. The computer-implemented method comprises receiving in real-time a set of messages between a member and a representative as the set of messages are being exchanged. The computer-implemented method further comprises automatically detecting an indication of a cognitive load change associated with the member. The indication is automatically detected based on the set of messages. The computer-implemented method further comprises determining a cognitive load associated with the member. The cognitive load is determined in response to the cognitive load change. Further, the cognitive load is determined based on a set of active tasks being performed for the member, a presentation of the set of active tasks, and the set of messages. The computer-implemented method further comprises determining that the cognitive load of the member exceeds a threshold. The computer-implemented method further comprises dynamically selecting one or more active tasks of the set for migration to a suspended state. The one or more active tasks are selected using a trained machine learning algorithm. Further, the trained machine learning algorithm uses a profile corresponding to the member, the set of active tasks, and the cognitive load to dynamically select the one or more active tasks. The computer-implemented method further comprises automatically migrating the one or more active tasks to the suspended state. The computer-implemented method further comprises performing one or more remaining active tasks of the set of active tasks. The computer-implemented method further comprises updating the trained machine learning algorithm. The trained machine learning algorithm is updated using the profile corresponding to the member, the cognitive load, and a new cognitive load resulting from migration of the one or more active tasks of the set to the suspended state.

In some embodiments, automatically detecting the indication of the cognitive load change includes processing the set of messages using a Natural Language Processing (NLP) algorithm to identify one or more anchor terms. The one or more anchor terms correspond to the cognitive load change.

In some embodiments, the computer-implemented method further comprises updating an active task interface to remove the one or more active tasks migrated to the suspended state.

In some embodiments, the computer-implemented method further comprises detecting completion of the one or more remaining active tasks of the set. The computer-implemented method further comprises identifying another cognitive load resulting from the completion of the one or more remaining active tasks. The computer-implemented method further comprises migrating an active task of the set from the suspended state to an active state. The active task is migrated to the active state based on the other cognitive load.

In some embodiments, the computer-implemented method further comprises dynamically generating one or more prompts for approval to migrate the one or more active tasks to the suspended state. When the one or more prompts are generated, the one or more prompts are provided to obtain the approval.

In some embodiments, the computer-implemented method further comprises transmitting a notification in response to determining that the cognitive load of the member exceeds the threshold. When the notification is received by the representative, the one or more active tasks of the set selected for migration are presented to the representative.

In some embodiments, the one or more active tasks of the set are selected based on a determination that a level of urgency for completion of the selected one or more active tasks is less than other active tasks of the set.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which an active task is automatically transitioned to a held state in response to a change in the cognitive load of a member in accordance with at least one embodiment;

FIG. 2 shows an illustrative example of an environment in which a task recommendation system automatically monitors the cognitive load of members and assigned representatives to determine whether to throttle one or more active tasks in accordance with at least one embodiment;

FIGS. 3A-3B show an illustrative example of an environment in which an active task is migrated to a held state as a result of the cognitive load of a member exceeding a threshold in accordance with at least one embodiment;

FIG. 4 shows an illustrative example of an environment in which a machine learning algorithm or artificial intelligence is implemented to process messages exchanged between a member and a representative to inform a representative of tasks transitioned to a held state as a result of a change in the cognitive load of the member in accordance with at least one embodiment;

FIG. 5 shows an illustrative example of an environment in which active tasks are automatically migrated to a held state in response to a termination of a member subscription to the task facilitation service in accordance with at least one embodiment;

FIGS. 6A-6B show an illustrative example of an environment in which machine learning algorithms or artificial intelligence is implemented to automatically re-assign one or more active tasks to other representatives as a result of a change in the cognitive load of the representative in accordance with at least one embodiment;

FIG. 7 shows an illustrative example of a process for transitioning one or more active tasks to a held state for later performance as a result of the cognitive load of a member exceeding a threshold in accordance with at least one embodiment;

FIG. 8 shows an illustrative example of a process for transitioning one or more active tasks to a suspended state as a result of termination of a member subscription to the task facilitation service in accordance with at least one embodiment;

FIG. 9 shows an illustrative example of a process for reducing the cognitive load of a representative as a result of the cognitive load of the representative exceeding a threshold in accordance with at least one embodiment;

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically identify and recommend tasks to a member of a task facilitation service in order to reduce the member's cognitive load. Through this framework, the task facilitation service can monitor communications between a member and an assigned representative to automatically identify possible tasks that can be performed for the benefit of the member. Further, the task facilitation service can automatically identify any additional information that may be required for the creation of these tasks. Once these tasks have been created, the task facilitation service can coordinate with the representative and/or third-party services to perform these tasks for the benefit of the member.

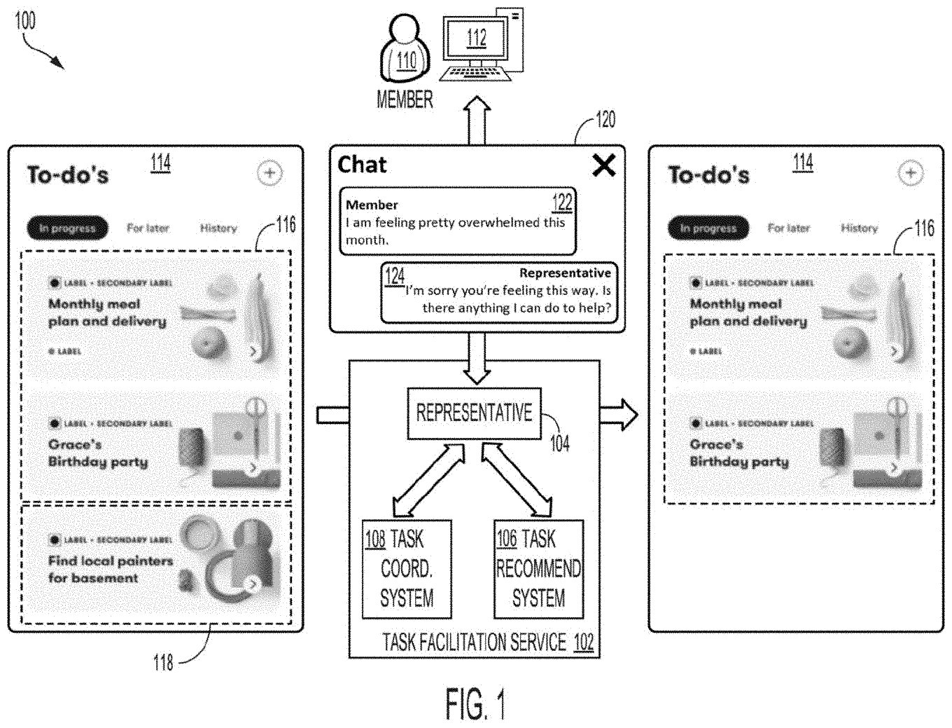

FIG. 1 shows an illustrative example of an environment 100 in which an active task 118 is automatically transitioned to a held state in response to a detected change in the cognitive load of a member 110 in accordance with at least one embodiment. In the environment 100, a member 110 of the task facilitation service 102 may be engaged in a communications session 120 with an assigned representative 104. The member 110, through the communications session 120, may transmit one or more messages 122 to the representative 104 to indicate that the member 110 is experiencing an increase in their cognitive load. For example, as illustrated in FIG. 1, the member 110 may indicate that they are feeling overwhelmed this month. The representative 104, in response to these one or more messages 122 may indicate, via one or more messages 124, that they may be able to assist the member 110 in reducing the member's cognitive load.

The task facilitation service 102 may be implemented to reduce the cognitive load on members and their families in performing various projects and tasks on behalf of these members and their families by identifying and delegating tasks to representatives that may coordinate performance of these tasks for the benefit of these members. A member, such as member 110, may be paired with a representative 104 during an onboarding process, through which the task facilitation service 102 may collect identifying information of the member 110. For instance, the task facilitation service 102 may provide, to the member 110, a survey or questionnaire through which the member 110 may provide identifying information usable to select a representative 104 for the member 110. The task facilitation service 102 may prompt the member 110 to provide detailed information with regard to the composition of the member's family (e.g., number of inhabitants in the member's home, the number of children in the member's home, the number and types of pets in the member's home, etc.), the physical location of the member's home, any special needs or requirements of the member 110 (e.g., physical or emotional disabilities, etc.), and the like. In some instances, the member 110 may be prompted to provide demographic information (e.g., age, ethnicity, race, languages written/spoken, etc.). The member 110 may also be prompted to indicate any information related to one or more tasks that the member 110 wishes to possibly delegate to a representative 104. This information may specify the nature of these tasks (e.g., gutter cleaning, installation of carbon monoxide detectors, party planning, etc.), a level of urgency for completion of these tasks (e.g., timing requirements, deadlines, date corresponding to upcoming events, etc.), any member preferences for completion of these tasks, and the like.

In an embodiment, the data associated with the member 110 is used by the task facilitation service 102 to create a member profile corresponding to the member 110. As noted above, the task facilitation service 102 may provide, to the member 110, a survey or questionnaire through which the member 110 may provide identifying information associated with the member 110. The responses provided by the member 110 to this survey or questionnaire may be used by the task facilitation service 102 to generate an initial member profile corresponding to the member 110. In an embodiment, once a representative has been assigned to the member 110, the task facilitation service 102 can prompt the member 110 to generate a new member profile corresponding to the member 110. For instance, the task facilitation service 102 may provide the member 110 with a survey or questionnaire that includes a set of questions that may be used to supplement the information previously provided during the aforementioned onboarding process. For example, through the survey or questionnaire, the task facilitation service 102 may prompt the member 110 to provide additional information about family members, important dates (e.g., birthdays, etc.), dietary restrictions, and the like. Based on the responses provided by the member 110, the task facilitation service 102 may update the member profile corresponding to the member 110.

In some instances, the member profile may be accessible to the member 110, such as through an application or web portal provided by the task facilitation service 102. Through the application or web portal, the member 110 may add, remove, or edit any information within the member profile. The member profile, in some instances, may be divided into various sections corresponding to the member, the member's family, the member's home, and the like. Each of these sections may be supplemented based on the data associated with the member 110 collected during the onboarding process and on any responses to the survey or questionnaire provided to the member 110 after assignment of a representative to the member 110. Additionally, each section may include additional questions or prompts that the member 110 may use to provide additional information that may be used to expand the member profile. For example, through the member profile, the member 110 may be prompted to provide any credentials that may be used to access any external accounts (e.g., credit card accounts, retailer accounts, etc.) in order to facilitate completion of tasks and projects.

The collected identifying information may be used by the task facilitation service 102 to identify and assign a representative 104 to the member 110. For instance, the task facilitation service 102 may use the identifying information of a member 110, as well as any information related to the member's level of comfort or interest in delegating tasks to others, and any other information obtained during the onboarding process as input to a classification or clustering algorithm configured to identify representatives that may be well-suited to interact and communicate with the member 110 in a productive manner. Using the classification or clustering algorithm, the task facilitation service 102 may identify a representative 104 that may be more likely to develop a positive, long-term relationship with the member 110 while addressing any tasks that may need to be addressed for the benefit of the member 110. In some instances, the task facilitation service 102 may select a representative 104 based on information corresponding to the availability of the set of representatives associated with the task facilitation service 102. For instance, the task facilitation service 102 may automatically select the first available representative from a set of representatives. In some instances, the task facilitation service 102 may automatically select the first available representative that satisfies one or more criteria corresponding to the member's identifying information. For example, the task facilitation service 102 may automatically select an available representative that is within geographic proximity of the member 110, shares a similar background as that of the member 110, and the like.

The representative 104 may be an individual that is assigned to the member 110 according to degrees or vectors of similarity between the member's and representative's demographic information. For instance, if the member 110 and the representative 104 share a similar background (e.g., attended university in the same city, are from the same hometown, share particular interests, etc.), the task facilitation service 102 may be more likely to assign the representative 104 to the member 110. Similarly, if the member 110 and the representative 104 are within geographic proximity to one another, the task facilitation service 102 may be more likely to assign the representative 104 to the member 110.

In an embodiment, the representative 104 can be an automated process, such as a bot, that may be configured to automatically engage and interact with the member 110. For instance, the task facilitation service 102 may utilize the responses provided by the member 110 during the onboarding process as input to a machine learning algorithm or artificial intelligence to generate a member profile and a bot that may serve as a representative 104 for the member 110. The bot may be configured to autonomously chat with the member 110 to generate tasks and proposals, perform tasks on behalf of the member 110 in accordance with any approved proposals, and the like as described herein. The bot may be configured according to the parameters or characteristics of the member 110 as defined in the member profile. As the bot communicates with the member 110 over time, the bot may be updated to improve the bot's interaction with the member 110.

When a representative 104 is assigned to the member 110 by the task facilitation service 102, the task facilitation service 102 may notify the member 110 and the representative 104 of the pairing. Further, the task facilitation service 102 may establish a chat session or other communications session between the member 110 and the assigned representative 104 to facilitate communications between the member 110 and the representative 104. For instance, via a web portal or an application provided by the task facilitation service 102 and installed on the computing device 112, the member 110 may exchange messages with the assigned representative 104 over the chat session or other communications session. Similarly, the representative 104 may be provided with an interface through which the representative may exchange messages with the member 110.

In an embodiment, the representative 104 can suggest one or more tasks based on member characteristics, task history, and other factors. For instance, as the member 110 communicates with the representative 104 over the communications session 120 and/or through any other communications session facilitated for different tasks and projects, the representative 104 may evaluate any messages 122 from the member 110 to identify any tasks that may be performed to reduce the member's cognitive load. As an illustrative example, if the member 110 indicates, over the communications session 120, that their spouse's birthday is coming up, the representative 104 may utilize their knowledge of the member 110 to develop one or more tasks that may be recommended to the member 110 in anticipation of their spouse's birthday. The representative 104 may recommend tasks such as purchasing a cake, ordering flowers, setting up a unique travel experience for the member 110, and the like. In some embodiments, the representative 104 can generate task suggestions without member input. For instance, as part of the onboarding process, the member 110 may provide the task facilitation service 102 with access to one or more member resources, such as the member's calendar, the member's personal fitness devices (e.g., fitness trackers, exercise equipment having communication capabilities, etc.), the member's vehicle data, and the like. Data collected from these member resources may be monitored by the representative 104, which may parse the data to generate task suggestions for the member 110.

In an embodiment, the task facilitation service 102, via a task recommendation system 106, can monitor the communications session 120 between the member 110 and the representative 104 in real time and as messages are exchanged to determine the member's cognitive load at any given time. The task recommendation system 106 may be implemented using a computer system or as an application or other executable code implemented on a computer system of the task facilitation service 102. In an embodiment, the task recommendation system 106 utilizes a machine learning algorithm, such as natural language processing (NLP) algorithm, or other artificial intelligence to process, in real-time, these messages as they are exchanged between the member 110 and the representative 104 over the communications session 120 to determine whether there has been a change to the member's cognitive load that may warrant further evaluation of active tasks being performed for the benefit of the member 110 and presented to the member 110 via an active task interface 114. For example, the task recommendation system 106 may process any incoming messages 122 from the member 110 in real-time and as these incoming messages 122 are exchanged using NLP or other artificial intelligence to detect any changes in the member's cognitive load that may warrant a re-evaluation of the active tasks being performed for the member 110 and/or of the presentation of these active tasks via the active task interface 114.

The machine learning algorithm or other artificial intelligence may be trained using supervised training techniques. For instance, a dataset of input messages, active tasks being performed and presented, and corresponding cognitive load can be selected for training of the machine learning algorithm or other artificial intelligence. The machine learning algorithm or artificial intelligence may be evaluated to determine, based on the sample inputs supplied to the machine learning algorithm or artificial intelligence, whether the machine learning algorithm or artificial intelligence is accurately calculating a member's cognitive load based on the sample messages and active tasks provided as input to the machine learning algorithm or artificial intelligence. The machine learning algorithm or artificial intelligence may further be dynamically trained by soliciting feedback from members and representatives of the task facilitation service 102 with regard to the determination of the member's cognitive load. For instance, if the task recommendation system 106 determines that the machine learning algorithm or artificial intelligence has failed to accurately determine the member's cognitive load given the member's active tasks and messages indicating that the member 110 is overwhelmed or otherwise experiencing a heightened level of stress, the task recommendation system 106 may use this feedback, along with the corresponding messages submitted by the member 110 indicating that they are overwhelmed or otherwise experiencing a heightened level of stress, as well as parameters corresponding to the member's active tasks, to retrain the machine learning algorithm or artificial intelligence to better determine the member's cognitive load.

In an embodiment, the machine learning algorithm or other artificial intelligence can be dynamically trained in real-time as messages are exchanged between the member 110 and the representative 104 over the communications session 120. For example, if the machine learning algorithm or artificial intelligence fails to identify, based on messages exchanged by the member 110 over the communications session 120, that the member 110 is overwhelmed or otherwise experiencing a heightened level of stress, and the member 110 at a later time transmits a message over the communications session 120 admonishing the representative 104 for failing to reduce the member's level of stress, the task recommendation system 106 may dynamically retrain the machine learning algorithm or artificial intelligence based on the feedback to increase the likelihood of the machine learning algorithm or artificial intelligence automatically determining the member's cognitive load. Alternatively, if the machine learning algorithm or artificial intelligence has successfully identified, based on messages exchanges between the member 110 and the representative 104, the member's current cognitive load, for which the member 110 has indicated that they are pleased with the representative's response to the member's cognitive load, the task recommendation system 106 may use the member's message indicating satisfaction with the identification of the member's cognitive load to dynamically reinforce the machine learning algorithm or artificial intelligence. This may increase the likelihood of the machine learning algorithm or artificial intelligence identifying the cognitive load of the member 110 and of other members associated with the task facilitation service 102 based on similar communications exchanged between members and representatives.

As illustrated in FIG. 1, if the member 110 indicates, in a message 122 to the representative 104 exchanged over the communications session 120, that the member 110 is feeling overwhelmed during a given month, the task recommendation system 106, using the machine learning algorithm or artificial intelligence (e.g., NLP), may detect that there has been a change in the member's cognitive load. Accordingly, the task recommendation system 106 may process the member's active tasks 116, 118 and the message 122 in real-time to automatically determine whether the member's cognitive load exceeds a threshold value and, if so, identify one or more actions that may be performed to reduce the member's cognitive load.

In an embodiment, the task recommendation system 106 may evaluate the active tasks 116, 118 that are being performed for the benefit of the member 110 and presented via the active task interface 114 to determine their contribution to the member's cognitive load. Certain tasks may increase the member's cognitive load at a higher rate than other tasks. For example, tasks related to routine or joyous events (e.g., monthly meal plan and delivery, birthday party planning, etc.) may have a lower impact on the member's cognitive load than tasks created to address significant issues or events that may be more stressful to the member 110 (e.g., finding local painters to address basement issues, repairs, etc.). Further, tasks may have different levels of urgency, which may contribute to the member's cognitive load. For instance, urgent or pressing tasks (e.g., tasks with short deadlines, tasks with fixed or non-extendable deadlines, tasks that are or paramount importance to the member 110, etc.) may provide a higher contribution to the member's cognitive load. Thus, through an evaluation of the member's active tasks 116, 118, the task recommendation system 106 may determine the contribution of each task to the member's cognitive load.

In an embodiment, the task recommendation system 106 implements a machine learning algorithm or other artificial intelligence to determine the contribution of each active task to the member's cognitive load. This machine learning algorithm or other artificial intelligence may be trained using unsupervised training techniques. For instance, a dataset of member profiles corresponding to different members associated with the task facilitation service 102, historical data corresponding to tasks and projects previously performed for these different members, and the cognitive load for each of the members prior to and after performance of tasks and projects associated with each of these members may be analyzed using a clustering algorithm to identify correlations between different types of tasks and projects and the cognitive load of different types of members. Example clustering algorithms that may be trained using sample member attributes and representative attributes (e.g., historical data, hypothetical data, etc.) to identify potential pairings may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm or artificial intelligence, the task recommendation system 106 may identify the contribution of each of the active tasks 116, 118 to the member's present cognitive load.

In addition to determining the impact of the various active tasks 116, 118 to the member's cognitive load, the task recommendation system 106 may determine the impact of the presentation of these active tasks 116, 118 via the active task interface 114 to the member's cognitive load. For example, the task recommendation system 106 may evaluate a member profile or other member-specific data to determine the member's preferences with regard to the amount of information that may be provided to the member 110 for different tasks and to the number of tasks that may be presented to the member 110 at any given time. For instance, while a member 110 may have several active tasks being performed on their behalf at any given time, the member 110 may have a preference to only be presented with a limited number of active tasks via the active task interface 114. If the task recommendation system 106 determines that the number of active tasks being presented via the active task interface 114 exceeds the preferred number indicated by the member 110, the task recommendation system 106 may remove one or more active tasks from the active task interface 114 and provide the member 110 with an option, via the active task interface 114, to access any other active tasks being performed for the member's benefit. Additionally, or alternatively, if the one or more active tasks presented via the active task interface 114 include excess information that the member 110 may not require or otherwise has previously indicated is unnecessary, the task recommendation system 106 may truncate the information provided via the active task interface 114. Thus, the task recommendation system 106 may ensure that the presentation of active tasks via the active task interface 114 does not overwhelm the member 110 or otherwise increase the member's cognitive load.

In an embodiment, if the task recommendation system 106 determines that the member's cognitive load exceeds a threshold value, the task recommendation system 106 can identify one or more active tasks currently being performed for the benefit of the member 110 and migrate these one or more active tasks to a held or suspended state. For example, as illustrated in FIG. 1, the task recommendation system 106 can migrate an active task 118 to a held or suspended state such that the member 110 may no longer be prompted with regard to the active task 118 until one or more other active tasks 116 are completed. The one or more active tasks that may be migrated to a held or suspended state may be selected based on one or more factors. For instance, the task recommendation system 106 may identify one or more active tasks that may have a lower level of urgency compared to other pending active tasks and that have not been initiated by the representative 104, the member 110, or a third-party service. As another example, the task recommendation system 106 may identify one or more active tasks that may have a lower priority to the member 110 and, thus, may be delayed for performance at a later time.

In some instances, the task recommendation system 106 may determine which one or more tasks to migrate to a held or suspended state based on the contribution of each of these tasks to the member's cognitive load. As noted above, the task recommendation system 106 may implement a machine learning algorithm or artificial intelligence that may automatically, and in real-time, determine the contribution of each of the active tasks 116, 118 to the member's cognitive load. Accordingly, the task recommendation system 106 may automatically evaluate the active tasks providing the highest contribution to the member's cognitive load to determine whether any of these active tasks may be migrated to a held or suspended state. For instance, the task recommendation system 106 may determine whether a task having the highest contribution to the member's present cognitive load may be delayed for performance at a later time (e.g., the deadline for completion of the task is not within a pre-defined time window, the member 110 has indicated that the task is not urgent, the member 110 has not indicated that the task is urgent, etc.). If the task may be migrated to a held or suspended state, the task recommendation system 106 may do so and determine, in real-time, the impact of migrating the task to a held or suspended state on the member's cognitive state. If the member's cognitive state continues to exceed the threshold value, the task recommendation system 106 may repeat the aforementioned process for the remaining active tasks and determine whether any of these remaining active tasks may be migrated to a held or suspended state.

In an embodiment, the task recommendation system 106 may implement one or more classical algorithms or processes to automatically determine which one or more tasks may be migrated to a held or suspended state. For instance, the one or more classical algorithms or processes may automatically, and in real-time, assign a value to each task based on the task type and temporal limitations for completion of the task (e.g., number of days before a deadline for completion of the task, etc.). For example, a task having a task type within a safety category (e.g., fire safety, home safety, vehicle safety, etc.) may be assigned a higher value compared to a task having a task type within other categories. Further, as another example, a task having a deadline within three days may be assigned a higher value compared to a task having a deadline within three weeks or with no deadline at all. These factors may be determined according to one or more pre-defined formulas that may be used by the one or more classical algorithms or processes to automatically calculate a cognitive load value for each of the active tasks.

The cognitive load values determined by the one or more classical algorithms or processes may be automatically weighed according to a member's preferences as defined within the member profile associated with the member 110. For example, if a member 110 has defined, within the member profile, that tasks related to home maintenance are to be assigned a greater level of urgency compared to tasks related to vehicle maintenance, the one or more classical algorithms or processes may automatically assign a greater weight to home maintenance tasks compared to vehicle maintenance tasks. This may result in a home maintenance task being assigned a higher cognitive load value compared to a vehicle maintenance task even though, without weighing, the vehicle maintenance task may originally have a higher cognitive load value or contribution to the member's cognitive load.

The one or more classical algorithms or processes may further automatically rank each of the active tasks according to their cognitive load values, with the active task having the highest cognitive load value being ranked highest. Based on this ranking, the task recommendation system 106 may evaluate the active task having the highest rank (e.g., highest cognitive load value) to determine whether the active task may be migrated to a held or suspended state. For instance, as noted above, the task recommendation system 106 may determine, based on the level of urgency for the active task, whether the active task may be migrated to a held or suspended state. In some examples, the one or more classical algorithms or processes may automatically migrate the active task having the lowest ranking (e.g., lowest cognitive load value) to a held or suspended state and determine whether this migration has reduced the member's cognitive load below the threshold value. If not, the one or more classical algorithms or processes may select the next active task having the lowest ranking to a held or suspended state. This process may continue until the member's cognitive load is below the threshold value. In some instances, the one or more classical algorithms or processes may provide the ranking to the representative 104. The representative 104 may evaluate the ranking to select which one or more active tasks may be migrated to a held or suspended state to reduce the member's cognitive load. Based on any selections made by the representative 104, the one or more classical algorithms or processes may automatically migrate any selected active tasks to a held or migrated state.

In an embodiment, the task recommendation system 106, upon identifying one or more active tasks that may be migrated to a held or suspended state, may provide a recommendation to the representative 104 to prompt the member 110 for approval to migrate one or more of these identified active tasks to a held or suspended state. The representative 104 may review the recommendation provided by the task recommendation system 106 and, via the communications session 120, prompt the member 110 to approve the recommended migration of the identified one or more active tasks to a held or suspended state, such that these one or more active tasks may be performed at a later time and such that the member 110 may no longer be prompted with regard to these tasks until they are migrated back to an active state for performance. In some instances, rather than providing the representative 104 with a recommendation to prompt the member 110 for their approval to migrate the identified active tasks to a held or suspended state, the task recommendation system 106 can automatically prompt the member 110 via the communications session 120 for their approval.

In an embodiment, the task recommendation system 106 automatically generates a specific communications session for each task when the task is generated. This specific communications session corresponding to a particular task may be distinct from the communications session 120 previously established between the member 110 and the representative 104. Through this task-specific communications session, the member 110 and the representative 104 may exchange messages related to the particular project or task. For example, through this task-specific communications session, the representative 104 may prompt the member 110 for information that may be required to determine one or more parameters of the task. Similarly, if the member 110 has questions related to the particular task, the member 110 may provide these questions through the task-specific communications session. The implementation of task-specific communications sessions may reduce the number of messages exchanged through other chat or communications sessions, such as the communications session 120, while ensuring that communications within these task-specific communications sessions are relevant to the corresponding tasks.

The representative 104 or the task recommendation system 106, in an embodiment, can prompt the member 110 through the task-specific communications session associated with the active task the representative 104 has selected for migration to approve the recommended migration of the particular active task to a held or suspended state. This may prevent a cluttering of the communications session 120 with myriad communications corresponding to migration of multiple active tasks to a held or suspended state. The reduction of these myriad communications through a single communications session (e.g., communications session 120) may reduce the member's cognitive load and may allow the member 110 to review each selected active task individually rather than collectively through the communications session 120.

If the member 110 approves of the migration of the identified one or more active tasks to a held or suspended state, the task recommendation system 106 may transition these identified one or more active tasks to the held or suspended state. Further, the task recommendation system 106 may notify the representative 104 of the transition. For instance, through a representative console, the task recommendation system may remove the transitioned tasks from a listing of active tasks that are to be performed for the benefit of the member 110. This may prevent or reduce the likelihood of the representative 104 communicating with the member 110 with regard to these tasks until these tasks are transitioned to an active state at a later time (e.g., one or more other active tasks are completed, the member's cognitive load is reduced to a particular level, etc.).

In an embodiment, the task recommendation system 106 can monitor the messages 122, 124 between the member 110 and the representative 104 in real-time and as they are exchanged over the communications session 120 to automatically identify the one or more active tasks that may be migrated to a held or suspended state. For instance, the task recommendation system 106 may process these messages 122, 124 using a machine learning algorithm or artificial intelligence, such as NLP, to identify any active tasks that the member 110 would like to transition to a held or suspended state. For example, if the member 110 expresses, in one or more messages 122, that tasks related to home maintenance are of lower priority but are otherwise causing the member 110 significant stress, the task recommendation system 106 may automatically transition active tasks corresponding to home maintenance and that have a lower level of urgency to a held or suspended state. Alternatively, the task recommendation system 106 may transmit a notification to the representative 104 to prompt the member 110 over the communications session 120 or through the task-specific communications sessions associated with these active tasks as to whether the representative 104 or task recommendation system 106 can migrate these active tasks to a held or suspended state.

Once the task recommendation system 106 has identified one or more active tasks that may be migrated to a held or suspended state, and has obtained approval from the member 110 for the migration (if approval is required), the task recommendation system 106 can update an entry corresponding to the identified one or more tasks to transition these tasks from an active state to a held or suspended state. Additionally, the task recommendation system 106 may update the active task interface 114 to remove the migrated tasks. For example, as illustrated in FIG. 1, the active task 118 is migrated from an active state to a held or suspended state. Accordingly, the task recommendation system 106 may update the active task interface 114 to remove the active task 118 while maintaining the other active tasks 116 that may be performed for the benefit of the member 110. This may reduce the number of tasks presented via the active task interface 114 and, thus, reduce the member's cognitive load. Further, because the active task 118 is migrated to a held or suspended state, this may reduce the number of tasks that the member 110 may need to track or monitor performance of at the given time. In some instances, the task recommendation system 106 may allow the member 110 to access the migrated tasks via selection of a “For Later” tab or other element of the interface 114. This may allow the member 110 to request performance of any of the held or suspended tasks should the member's prioritization of these tasks change.

In an embodiment, the task recommendation system 106, in addition to determining in real time the cognitive load of the member 110, can determine the cognitive load of the representative 104 and determine whether one or more actions are to be performed to reduce the representative's cognitive load. For instance, the task recommendation system 106 may obtain the active tasks assigned to the representative 104 that are to be performed for the benefit of the member 110 and for any other members the representative 104 is assigned to. Similar to the evaluation of the active tasks 116, 118 that are being performed for the benefit of the member 110 and presented via the active task interface 114 in order to determine their contribution to the member's cognitive load, the task recommendation system 106 may determine the contribution of each of the active tasks assigned to the representative 104 to the representative's cognitive load.

Certain tasks may increase the representative's cognitive load at a higher rate than other tasks. For instance, tasks that require active representative participation and/or require more steps or actions to complete may contribute to a higher cognitive load than simpler tasks (e.g., tasks with fewer steps or actions) or tasks that are primarily performed by one or more third-party services or other services/entities affiliated with the task facilitation service 102 but are otherwise monitored by the representative 104. Further, certain types or categories of tasks may contribute to a higher representative cognitive load compared to other types or categories of tasks. For example, tasks related to a move to a new location may require significant coordination and monitoring, which may result in a higher cognitive load compared to tasks related to simple maintenance tasks, such as gutter cleaning or oil changes.

As noted above, the task recommendation system 106 may use a machine learning algorithm, such as NLP, or other artificial intelligence to process the messages exchanged between the member 110 and the representative 104 over the communications session 120 and/or any task-specific communications sessions to determine whether there has been a change to the member's cognitive load that may warrant further evaluation of active tasks being performed for the benefit of the member 110 and presented to the member 110 via an active task interface 114. Similarly, the task recommendation system 106 may use this machine learning algorithm or artificial intelligence to detect any changes to the representative's cognitive load. For example, if during the a task-specific communications session corresponding to a particular active task the member 110 seeks to obtain an update with regard to an active task and the representative 104 indicates, in response to the member's request for an update, that the representative 104 is overwhelmed or that they are trying to complete other active tasks before beginning working on the active task indicated by the member 110, the task recommendation system 106 may determine that there has been a change in the representative's cognitive load that may warrant a re-evaluation of the active tasks assigned to the representative 104.

In an embodiment, the task recommendation system 106 can perform one or more actions to reduce the representative's cognitive load should the representative's cognitive load exceed a threshold value. For example, if the task recommendation system 106 determines that the representative's cognitive load exceeds a threshold value, the task recommendation system 106 may determine whether one or more active tasks assigned to the representative 104 can be migrated to a held or suspended state such that the number of active tasks that are assigned to the representative 104 is reduced. The one or more active tasks that may be migrated to a held or suspended state may be selected based on one or more factors. For instance, the task recommendation system 106 may identify one or more active tasks that may have a lower level of urgency compared to other pending active tasks and that have not been initiated by the representative 104 or a third-party service. As another example, the task recommendation system 106 may identify one or more active tasks that may have a lower priority to the member 110 and, thus, may be delayed for performance at a later time. The task recommendation system 106 may utilize one or more classical algorithms or processes, as described above with regard to migration of active tasks to a held or suspended state for a member 110, to similarly assign a cognitive load value to each active task assigned to the representative 104 and to rank these active tasks accordingly.

It should be noted that, as opposed to how active tasks may be migrated to a held or suspended state from the member's perspective such that these migrated tasks are removed from the active task interface 114 for the benefit of the member 110, any active tasks that are migrated to a held or suspended state from the representative's perspective may still be displayed as an active task within the active task interface 114. This may allow the representative 104 to reduce their cognitive load without alarming the member 110 with regard to the migration of an active task to a held or suspended state, which may serve as an indication that the active task may not be completed. Further, this allows the member 110 to continue monitoring the active task through the active task interface 114 while the task may be in a held or suspended state from the representative's perspective, thereby comporting with the member's preferences.

In an embodiment, if the task recommendation system 106 identifies one or more active tasks that can be migrated to a held or suspended state to reduce the representative's cognitive load, the task recommendation system 106 can provide a recommendation to the representative 104 to communicate with the member 110 over the communications session 120 or task-specific communications sessions corresponding to the one or more active tasks to obtain the member's approval to migrate these active tasks to the held or suspended state. For instance, the task recommendation system 106 may provide a recommendation corresponding to one or more messages that may be exchanged by the representative 104 over the communications session 120 or the task-specific communications sessions corresponding to the one or more active tasks to obtain the member's approval for migrating the identified one or more active tasks to a held or suspended state. For example, the recommendation may instruct the representative 104 to indicate that migration of these one or more active tasks to a held or suspended state may allow the representative 104 to better focus on more urgent active tasks for the benefit of the member 110. If the member 110 approves of the proposed migration of one or more active tasks to a held or suspended state in order to reduce the representative's cognitive load, the task recommendation system 106 may perform this migration and update the active task interface 114 to remove any active tasks that have been migrated to the held or suspended state.

In an embodiment, if the task recommendation system 106 determines that one or more active tasks cannot be migrated to a held or suspended state in order to reduce the representative's cognitive load (e.g., the member 110 has rejected a recommendation to migrate one or more active tasks to a held or suspended state, the active tasks are urgent or critical to the member 110, etc.), the task recommendation system 106 can automatically identify one or more other representatives that may perform the identified one or more active tasks on behalf of the representative 104 in order to satisfy the member's requirements for completion of these tasks. For instance, the task recommendation system 106 may determine the cognitive load of the various representatives associated with the task facilitation service 102 to identify one or more representatives whose cognitive load is below the threshold value and who may be able to perform any of the one or more identified active tasks without cause their cognitive load to exceed the threshold value. In an embodiment, the task recommendation system 106 can automatically evaluate, in real-time, each of the identified representatives to determine whether these representatives can perform the one or more active tasks (e.g., are experienced in performing such tasks, have worked with similarly-situated members with regard to similar tasks, etc.). In an embodiment, the task recommendation system 106 utilizes a classification or clustering algorithm configured to identify representatives that may be well-suited to perform certain tasks or categories/types of tasks. For instance, representatives may be profiled based on various criteria, including (but not limited to) demographics and other identifying information, geographic location, experience in handling different categories of tasks, experience in communicating with different categories of members, and the like. Using the classification or clustering algorithm, the task recommendation system 106 may identify a set of representatives that may be more likely to perform the identified one or more active tasks on behalf of the representative 104 in a satisfactory manner.

Once the task recommendation system 106 has identified a set of representatives that may perform the identified one or more tasks on behalf of the representative 104, the task recommendation system 106 may delegate the identified one or more active tasks to one or more representatives of the set of representatives. For instance, the task recommendation system 106 can utilize a task coordination system 108 of the task facilitation service 102 to delegate the identified one or more tasks to the one or more representatives and to allow for coordination of performance of these tasks between the one or more representatives and the representative 104. The task coordination system 108 may be implemented using a computer system or as an application or other executable code implemented on a computer system of the task facilitation service 102. In an embodiment, the task coordination system 108 allows the representative 104 to monitor performance of the other representatives to which the one or more active tasks have been delegated. For instance, the task coordination system 108 may establish a communications session between the representative 104 and the other representatives selected by the task recommendation system 106 to allow the representative 104 to monitor performance of the one or more active tasks and provide any insights that may assist these other representatives in performing the one or more active tasks. This may also allow the representative 104 to provide updates to the member 110 over the task-specific communications sessions corresponding to the one or more active tasks with regard to the performance of these one or more active tasks. In some instances, the task coordination system 108 may allow the other representatives to communicate with the member 110 through the task-specific communications sessions corresponding to the one or more active tasks.

In an embodiment, the task coordination system 108 can monitor, in real-time, performance of the one or more active tasks by the representative 104 and any other representatives to which one or more active tasks originally assigned to the representative 104 may have been delegated. For instance, the task coordination system 108 may monitor, in real-time, any communications between the representative 104 and the member 110 regarding the representative's (or other representative's) performance of the active task. These communications may include messages 124 from the representative 104 or any other representative delegated to perform the task over the task-specific communications sessions corresponding to the active task indicating any status updates with regard to performance of the task, any purchases or expenses incurred by the representative 104 or other assigned representative in performing the task, the timeframe for completion of the task, and the like. The task coordination system 108 may further use these messages from the representative 104 to automatically update the active task interface 114 to provide the member 110 with updates related to the performance of the active tasks 116.

Once an active task has been completed, the member 110 may be prompted to provide feedback with regard to completion of the active task. For instance, the member 110 may be prompted to provide feedback with regard to the performance and professionalism of the selected third-party services or other services/entities affiliated with the task facilitation service 102 in performance of the active task. Further, the member 110 may be prompted to provide feedback with regard to the performance of the representative 104 or of any other representative assigned to perform the task. Using the responses provided by the member 110, the task facilitation service 102 may train or otherwise update the machine learning algorithms or artificial intelligence utilized by the task recommendation system 106 and the task coordination system 108 to provide better determination of the member's and representative's cognitive load, recommendations for migrating active tasks to a held or suspended state, identification of other representatives for completion of tasks for the benefit of the member 110 and on behalf of the representative 104, and the like.

It should be noted that for the processes described herein, various operations performed by the representative 104 may be additionally, or alternatively, performed using one or more machine learning algorithms or artificial intelligence. For example, as the representative 104 performs or otherwise coordinates performance of tasks on behalf of a member 110 over time, the task facilitation service 102 may continuously and automatically update the member profile associated with the member 110 according to member feedback related to the performance of these tasks by representatives and/or third-party services or other services/entities affiliated with the task facilitation service 102. In an embodiment, the task recommendation system 106, after a member profile has been updated over a period of time (e.g., six months, a year, etc.) or over a set of tasks (e.g., twenty tasks, thirty tasks, etc.), may utilize a machine learning algorithm or artificial intelligence to automatically and dynamically generate new tasks based on the various attributes of the member profile (e.g., historical data corresponding to member-representative communications, member feedback corresponding to representative performance and presented tasks/proposals, etc.) with or without representative 104 interaction. The task recommendation system 106 may automatically communicate with the member 110 to obtain any additional information required for new tasks and automatically generate proposals that may be presented to the member 110 for performance of these tasks. The representative 104 may monitor communications between the task recommendation system 106 and the member 110 to ensure that the conversation maintains a positive polarity (e.g., the member 110 is satisfied with their interaction with the task recommendation system 106 or other bot, etc.). If the representative 104 determines that the conversation has a negative polarity (e.g., the member 110 is expressing frustration, the task recommendation system 106 or bot is unable to process the member's responses or asks, etc.), the representative 104 may intervene in the conversation. This may allow the representative 104 to address any member concerns and perform any projects and tasks on behalf of the member 110.

Thus, unlike automated customer service systems and environments, wherein these systems and environment may have little to no knowledge of the users interacting with agents or other automated systems, the task recommendation system 106 can continuously update the member profile to provide up-to-date historical information about the member 110 based on the member's automatic interaction with the system or interaction with the representative 104 and on the projects and tasks performed on behalf of the member 110 over time. This historical information, which may be automatically and dynamically updated as the member 110 or the system interacts with the representative 104 and as tasks are devised, proposed, and performed for the member 110 over time, may be used by the task recommendation system 106 to anticipate, identify, and present appropriate or intelligent responses to member 110 queries, needs, and/or goals.

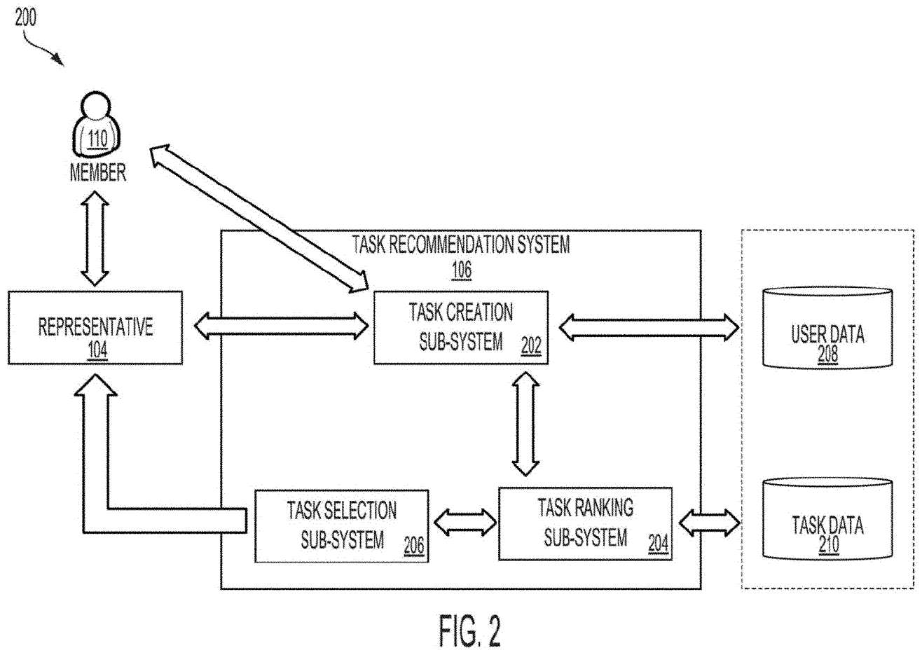

FIG. 2 shows an illustrative example of an environment 200 in which a task recommendation system 106 automatically monitors the cognitive load of members and assigned representatives to determine whether to throttle one or more active tasks in accordance with at least one embodiment. In the environment 200, a member 110 and/or representative 104 interacts with a task creation sub-system 202 of the task recommendation system 106 to generate a new task that can be performed for the benefit of the member 110. The task creation sub-system 202 may be implemented using a computer system or as an application or other executable code implemented on a computer system of the task recommendation system 106.

In an embodiment, a member 110 can access the task creation sub-system 202 to manually generate a new task that may be assigned to a representative 104 and/or one or more third-party services for performance of the new task or project for the benefit of the member 110. For instance, a member 110 may explicitly indicate to the representative 104 that they require assistance with regard to a particular issue. As an illustrative example, the member 110 may indicate, in a message to the representative 104 over a communications session, that they would like assistance with an upcoming move to a new town. The representative 104 may evaluate this message and determine that the member 110 has defined an issue for which a task may be generated to address the issue. Alternatively, the member 110 may directly access the task creation sub-system 202 to request creation of a task corresponding to a particular issue that the member 110 would like assistance with. For instance, the task facilitation service may provide, via an application or web portal of the task facilitation service an option for manual entry of a project or task that may be delegated to the representative 104 or that may otherwise be added to the member's list of projects and tasks.

If the member 110 selects an option for manual entry of a project or task, the task facilitation service may provide, via an interface of the application or web portal, a project or task template through which the member may enter various details related to the project or task. The project or task template may include various fields through which the member 110 may provide a name for the project or task, a description of the project or task (e.g., “I need to have my gutters cleaned before the upcoming storm,” “I'd like to have painters touch up my powder room,” etc.), a timeframe for performance of the project or task (e.g., a specific deadline date, a date range, a level of urgency, etc.), a budget for performance of the project or task (e.g., no budget limitation, a specific maximum amount, etc.), and the like.

In some instances, if the member 110 selects an option for manual entry of a project or task, the task facilitation service may provide the member 110 with different project and task templates that may be used to generate a new project or task. As noted above, the task facilitation service may maintain a resource library that serves as a repository for different project and task templates corresponding to different project and task categories (e.g., vehicle maintenance tasks, home maintenance tasks, family-related event tasks, care giving tasks, experience-related tasks, etc.). A project or task template may include a plurality of project or task definition fields that may be used to define a project or task that may be performed for the benefit of the member 110. For example, the task definition fields corresponding to a vehicle maintenance task may be used to define the make and model of the member's vehicle, the age of the vehicle, information corresponding to the last time the vehicle was maintained, any reported accidents associated with the vehicle, a description of any issues associated with the vehicle, and the like. Thus, each template maintained in the resource library may include fields that are specific to the project or task category associated with the template.

In an embodiment, the task creation sub-system 202 can monitor, automatically and in real-time, messages as these messages are exchanged between the member 110 and the representative 104 over a communications session to identify a task that can be performed for the benefit of the member 110 in order to address an issue specified by the member 110 over the communications session. For instance, the task creation sub-system 202 may process, in real-time, messages between the member 110 and the representative 104 as these messages are being exchanged using a machine learning algorithm or artificial intelligence to automatically identify any tasks for which the representative 104 and the task facilitation service may provide assistance to the member 110 for addressing a stated issue. The task creation sub-system 202 may utilize NLP or other artificial intelligence to evaluate these exchanged messages or other communications from the member 110 in real-time to identify any tasks that may be performed in order to address an issue expressed by the member 110. In some instances, the task creation sub-system 202 may utilize historical data corresponding to previously identified tasks for similarly-situated members and corresponding messages from these members from a user datastore 208 to train the NLP or other artificial intelligence to identify possible tasks. If the task creation sub-system 202 identifies one or more tasks that may be performed to address a specified issue, the task creation sub-system 202 may present these tasks to the representative 104.

In an embodiment, if the task creation sub-system 202 identifies a project or task that may be performed in order to address an issue expressed by the member 110, the task creation sub-system 202 automatically facilitates a communications session that is specific to the identified project or task. This communications session may differ from the original communications session facilitated by the task facilitation service and between the member 110 and the representative 104. This project or task-specific communications session may be presented through an interface that is specific to the identified project or task. For example, if the task creation sub-system 202 identifies a project or task that may be performed in order to address an issue expressed by the member 110, the task creation sub-system 202 may automatically generate a new interface corresponding to this identified project or task. This new interface may be presented to the member 110 through the application or web portal provided by the task facilitation service. Through this interface, the task creation sub-system 202 may facilitate a communications session between the member 110 and the representative 104, through which the member 110 and the representative 104 may exchange communications corresponding to the identified project or task.

In an embodiment, if the member 110 submits a request to generate a new task to address a particular issue, the task creation sub-system 202 can automatically, and in real-time, process messages exchanged between the member 110 and the representative 104 over the communications session to identify any keywords and/or anchor terms that may be used to identify, from the set of templates stored in the task datastore 210, one or more templates that may be associated with these keywords and/or anchor terms and used to generate the new task. For instance, the task creation sub-system 202 may use NLP or other artificial intelligence to process these messages exchanged between the member 110 and the representative 104 over the communications session to identify the one or more keywords or anchor terms that may correspond to particular tasks. Using the identified one or more keywords or anchor terms, the task creation sub-system 202 may automatically identify one or more templates that may be presented to the representative 104 for defining the new task.

The task recommendation system 106 may further include a task ranking sub-system 204, which may be configured to rank the set of tasks of a member 110, including tasks and/or projects that may be recommended to the member 110 for completion by the member 110, the representative 104, or one or more third-party services and/or other services/entities associated with the task facilitation service. The task ranking sub-system 204 may be implemented using a computer system or as an application or other executable code implemented on a computer system of the task recommendation system 106. In an embodiment, the task ranking sub-system 204 can rank the listing of the set of tasks based on a likelihood of the member 110 selecting the task for delegation to the representative for performance and coordination with third-party services and/or other services/entities associated with the task facilitation service. Alternatively, the task ranking sub-system 204 may rank the listing of the set of tasks based on the level of urgency for completion of each task. The level of urgency may be determined based on member characteristics from the user datastore 208 (e.g., data corresponding to a member's own prioritization of certain tasks or categories of tasks) and/or potential risks to the member 110 if the task is not performed.

In an embodiment, the task ranking sub-system 204 may further rank the set of tasks based on the predicted impact of each task to the member's present cognitive load. As noted above, certain tasks may increase the member's cognitive load at a higher rate than other tasks. For example, tasks related to routine or joyous events may have a lower impact on the member's cognitive load than tasks created to address significant issues or events that may be more stressful to the member 110. Further, tasks may have different levels of urgency, which may contribute differently to the member's cognitive load. For instance, urgent or pressing tasks may provide a higher contribution to the member's cognitive load. In an embodiment, the task ranking sub-system 204 can determine, based on the predicted impact of each task of the set of tasks, whether implementation of a new task would result in the member's cognitive load being increased over a threshold value. If so, the new task may be ranked lower compared to other tasks of the set of tasks that may not impact the member's cognitive load in a manner that would result in the member's cognitive load exceeding the threshold value.

In an embodiment, the task ranking sub-system 204 can rank the set of tasks and any currently active tasks already presented to the member 110 to generate a ranked list of these tasks that may be recommended to the member 110. For instance, the task ranking sub-system 204 may rank the set of active tasks and the newly generated set of tasks according to the level of urgency for completion of each task, such that more urgent tasks may be assigned a higher ranking compared to less urgent tasks. In some instances, the task ranking sub-system 204 may generate and rank different groupings of tasks according to the predicted member cognitive load for each grouping of tasks. A grouping of tasks may include one or more active and/or new tasks that may be performed for the benefit of the member 110. Each grouping of tasks may be generated such that the total cognitive load corresponding to the tasks of the grouping does not exceed a cognitive load threshold value. Further, each grouping of tasks may include a combination of tasks selected according to the member's preferences (as defined in a member profile from the user datastore 208), the level of urgency for completion of the tasks, the diversity of tasks, and the like.

In an embodiment, the task ranking sub-system 204 provides the ranked list of the set of tasks that may be recommended to the member 110 to a task selection sub-system 206. The task selection sub-system 206 may be implemented using a computer system or as an application or other executable code implemented on a computer system of the task recommendation system 106. The task selection sub-system 206 may be configured to select, from the ranked list of the set of tasks, which tasks may be recommended to the member 110 by the representative 104. For instance, if the application or web portal provided by the task facilitation service is configured to present, to the member 110, a limited number of task recommendations from the ranked list of the set of tasks, the task selection sub-system 206 may process the ranked list and the member profile associated with the member 110 from the user datastore 208 to determine which task recommendations should be presented to the member 110. In some instances, the selection made by the task selection sub-system 206 may correspond to the ranking of the set of tasks in the list. Alternatively, the task selection sub-system 206 may process the ranked list of the set of tasks, as well as the member profile associated with the member 110 and the member's existing tasks (e.g., active tasks in progress, active tasks accepted by the member 110, etc.), to determine which tasks may be recommended to the member 110. For instance, if the ranked list of the set of tasks includes a task corresponding to gutter cleaning but the member 110 already has a task in progress corresponding to gutter repairs due to a recent storm, the task selection sub-system 206 may forego selection of the task corresponding to gutter cleaning, as this may be performed in conjunction with the gutter repairs. Thus, the task selection sub-system 206 may provide another layer to further refine the ranked list of the set of tasks for presentation to the member 110.

The task selection sub-system 206 may provide, to the representative 104, a new listing of tasks that may be recommended to the member 110. The representative 104 may review this new listing of tasks to determine which tasks may be presented to the member 110 via the communication session or through task-specific communications sessions corresponding to each of these tasks. For instance, the representative 104 may review the set of tasks recommended by the task selection sub-system 206 and select one or more of these tasks for presentation to the member 110 via the communication session or through task-specific communications sessions corresponding to the selected one or more tasks. In some instances, the one or more tasks may be presented to the member 110 according to the ranking generated by the task ranking sub-system 204 and refined by the task selection sub-system 206. Alternatively, the one or more tasks may be presented according to the representative's understanding of the member's own preferences for task prioritization. Through an interface associated with the communication session (e.g., the active task interface 114, as illustrated in FIG. 1), the member 110 may select one or more tasks that may be performed with the assistance of the representative 104 and/or of third-party services and/or other services/entities associated with the task facilitation service. The member 110 may alternatively dismiss any presented tasks that the member 110 would rather perform personally or that the member 110 does not otherwise want performed.

In an embodiment, the task selection sub-system 206 monitors, in real-time, the communication session between the member 110 and the representative 104 as messages are exchanged to determine the member's cognitive load. For example, the task selection sub-system 206 may use a machine learning algorithm, such as NLP, or other artificial intelligence to process the messages exchanged between the member 110 and the representative 104 over the communications session to determine whether there has been a change to the member's cognitive load that may warrant further evaluation of active tasks being performed for the benefit of the member 110 and presented to the member 110 via an active task interface. For instance, if the member 110 submits a message to the representative 104 that they are feeling overwhelmed with the number and/or types of active tasks currently being performed for the benefit of the member 110, the task selection sub-system 206 may process this message and determine that the member's cognitive load may have increased to a level that exceeds a threshold value.

In some instances, rather than using a machine learning algorithm or other artificial intelligence to automatically, and in real-time, process the messages exchanged between the member 110 and the representative 104 as these messages are exchanged to determine the member's cognitive load, the task selection sub-system 206 may implement one or more classical algorithms or processes to automatically determine the member's cognitive load. For example, these one or more classical algorithms or processes may process exchanged communications in real-time to identify a set of anchor words or phrases corresponding to the member's current cognitive load. As an illustrative example, if a member 110 communicates, to the representative 104 that “I am feeling pretty overwhelmed this month,” the one or more classical algorithms or processes may identify the anchor terms “feeling” and “overwhelmed.” The anchor term “feeling” may correspond to an expression of a cognitive load associated with the member 110. Further, the anchor term “overwhelmed,” when combined with the previous anchor term “feeling,” may denote the type or level of cognitive load being experienced by the member 110. Thus, based on a communication expressed by the member 110 through the communications session, the one or more classical algorithms or processes may automatically, and in real-time, determine the member's cognitive load.

In an embodiment, the task selection sub-system 206 can further monitor, periodically and/or in real time, the set of active tasks being performed for the benefit of the member 110 to determine the member's cognitive load and to perform any remedial actions should the member's cognitive load exceed a threshold value. For instance, the task selection sub-system 206 may evaluate the active tasks that are being performed for the benefit of the member 110 to determine their contribution to the member's cognitive load. Further, in addition to determining the impact of the various active tasks on the member's cognitive load, the task selection sub-system 206 may determine the impact of the presentation of these active tasks via an active task interface (e.g., active task interface 114, as illustrated in FIG. 1) to the member's cognitive load. For example, the selection sub-system 206 may evaluate a member profile or other member-specific data from the user datastore 208 to determine the member's preferences with regard to the amount of information that may be provided to the member 110 for different tasks and to the number of tasks that may be presented to the member 110 at any given time. For instance, if the task selection sub-system 206 determines that the number of active tasks being presented to the member 110 exceeds a preferred number indicated by the member 110, the task selection sub-system 206 may remove one or more active tasks from the active task interface and provide the member 110 with an option to access any other active tasks being performed for the member's benefit. Additionally, or alternatively, if the one or more active tasks presented to the member 110 include excess information that the member 110 may not require or otherwise has previously indicated is unnecessary, the task selection sub-system 206 may truncate the information provided for each of the one or more active tasks.

If the task selection sub-system 206 determines that the member's cognitive load exceeds a threshold value, the task selection sub-system 206 may identify one or more active tasks currently being performed for the benefit of the member 110 that may be migrated to a held or suspended state. For instance, the task selection sub-system 206 may migrate an active task to a held or suspended state such that the member 110 may no longer be prompted with regard to the active task until one or more other active tasks are completed and/or the member's cognitive load is reduced to a level where the task may be migrated back to an active state to be presented and performed for the benefit of the member 110. The task selection sub-system 206 may select the one or more active tasks that may be migrated to a held or suspended state based on one or more factors. For instance, the task selection sub-system 206 may identify one or more active tasks that may have a lower level of urgency compared to other pending active tasks and that have not been initiated by the representative 104, the member 110, or a third-party service. As another example, the task selection sub-system 206 may identify one or more active tasks that may have a lower priority to the member 110 and, thus, may be delayed for performance at a later time.

As noted above, to identify which active tasks may be migrated to a held or suspended state, the task selection sub-system 206 may implement a machine learning algorithm or artificial intelligence that may automatically, and in real-time, determine the contribution of each of the active tasks to the member's cognitive load. Accordingly, the task selection sub-system 206 may automatically evaluate the active tasks providing the highest contribution to the member's cognitive load to determine whether any of these active tasks may be migrated to a held or suspended state. In some instances, the task selection sub-system 206 may implement one or more classical algorithms or processes to automatically, and in real-time, assign a value to each task based on the task type and temporal limitations for completion of the task (e.g., number of days before a deadline for completion of the task, etc.). These factors may be determined according to one or more pre-defined formulas that may be used by the one or more classical algorithms or processes to automatically calculate a cognitive load value for each of the active tasks. Based on the assigned cognitive load values for each of the one or more active tasks, the one or more classical algorithms or processes may automatically rank each of the active tasks, with the active task having the highest cognitive load value being ranked highest. Based on this ranking, the task selection sub-system 206 may evaluate the active task having the highest rank (e.g., highest cognitive load value) to determine whether the active task may be migrated to a held or suspended state. Alternatively, the task selection sub-system 206 may automatically migrate the active task having the lowest ranking (e.g., lowest cognitive load value) to a held or suspended state and determine whether this migration has reduced the member's cognitive load below the threshold value. If not, task selection sub-system 206 may select the next active task having the lowest ranking to a held or suspended state. This process may continue until the member's cognitive load is below the threshold value. In some instances, the one or more classical algorithms or processes may provide the ranking to the representative 104. The representative 104 may evaluate the ranking to select which one or more active tasks may be migrated to a held or suspended state to reduce the member's cognitive load.

In some instances, the task selection sub-system 206 may provide a recommendation to the representative 104 to prompt the member 110 for approval to migrate one or more active tasks to a held or suspended state. As noted above, the representative 104 may review the recommendation provided by the task selection sub-system 206 and prompt the member 110 to approve the recommended migration of the identified one or more active tasks to a held or suspended state. In some instances, rather than providing the representative 104 with a recommendation to prompt the member 110 for their approval to migrate the identified active tasks to a held or suspended state, the task selection sub-system 206 can automatically prompt the member 110 via the task-specific communications sessions corresponding to the identified one or more active tasks for their approval. If the member 110 approves of the migration of the identified one or more active tasks to a held or suspended state, the task selection sub-system 206 may transition these identified one or more active tasks to the held or suspended state. Further, the task selection sub-system 206 may notify the representative 104 of the transition.

The task selection sub-system 206 may also monitor, in real-time, messages between the member 110 and the representative 104 as they are exchanged over the communications session and/or the task-specific communications sessions corresponding to the member's active tasks to automatically identify the one or more active tasks that may be migrated to a held or suspended state. For instance, the task selection sub-system 206 may process these messages using a machine learning algorithm or artificial intelligence, such as NLP, to identify any active tasks that the member 110 would like to transition to a held or suspended state. If the task selection sub-system 206 identifies one or more active tasks that may be migrated to a held or suspended state, the task selection sub-system 206 may automatically transition these active tasks to a held or suspended state. Alternatively, the task selection sub-system 206 may transmit a notification to the representative 104 to prompt the member 110, over the communications session and/or the task-specific communications sessions corresponding to the identified one or more active tasks, as to whether the representative 104 or task selection sub-system 206 can migrate these active tasks to a held or suspended state.

Once the task selection sub-system 206 has obtained approval from the member 110 for the migration of the identified one or more active tasks (if approval is required), the task selection sub-system 206 can update an entry corresponding to the identified one or more tasks in the task datastore 210 to transition these tasks from an active state to a held or suspended state. Additionally, the task selection sub-system 206 may update the active task interface to remove the migrated tasks while maintaining the other active tasks that may be performed for the benefit of the member 110. This may reduce the number of tasks presented via the active task interface and, thus, reduce the member's cognitive load. Further, this may reduce the number of tasks that the member 110 may need to track or monitor performance of at the given time.

In addition to determining the cognitive load of the member 110, the task selection sub-system 206 may determine the cognitive load of the representative 104 assigned to the member 110. Based on the cognitive load of the representative 104, the task selection sub-system 206 may determine whether one or more actions are to be performed in order to reduce the representative's cognitive load. For instance, the task selection sub-system 206 may obtain the active tasks assigned to the representative 104 that are to be performed for the benefit of the member 110 and for any other members the representative is assigned to. Similar to the evaluation of the active tasks that are being performed for the benefit of the member 110 in order to determine their contribution to the member's cognitive load, the task selection sub-system 206 may determine the contribution of each of the active tasks assigned to the representative 104 to the representative's cognitive load.

In an embodiment, the task selection sub-system 206 may use a machine learning algorithm, such as NLP, or other artificial intelligence to process the messages exchanged between the member 110 and the representative 104 over the communications session to detect a change in the representative's cognitive load. For example, if the representative 104 expresses, over the communication session between the member 110 and the representative 104, that they are overwhelmed or that they are trying to complete other active tasks before beginning work on the active task indicated by the member 110, the task selection sub-system 206 may determine a change in the representative's cognitive load that may warrant a re-evaluation of the active tasks assigned to the representative 104. The task selection sub-system 206 may alternatively utilize one or more classical algorithms or processes, as described above with regard to migration of active tasks to a held or suspended state for a member 110, to similarly determine a change in the representative's cognitive load, assign a cognitive load value to each active task assigned to the representative 104, and to rank these active tasks accordingly.

If the task selection sub-system 206 determines that the representative's cognitive load exceeds a threshold value, the task selection sub-system 206 may determine whether one or more active tasks assigned to the representative 104 can be migrated to a held or suspended state. The one or more active tasks that may be migrated to a held or suspended state may be selected based on one or more factors. For instance, the task selection sub-system 206 may identify one or more active tasks that may have a lower level of urgency compared to other pending active tasks and that have not been initiated by the representative 104 or a third-party service or other service/entity affiliated with the task facilitation service. As another example, the task selection sub-system 206 may identify one or more active tasks that may have a lower priority to the member 110 and, thus, may be delayed.

In an embodiment, if the task selection sub-system 206 identifies one or more active tasks that can be migrated to a held or suspended state to reduce the representative's cognitive load, the task selection sub-system 206 can provide a recommendation to the representative 104 to communicate with the member 110 to obtain the member's approval for migration of these active tasks to the held or suspended state. For example, the recommendation may instruct the representative 104 to indicate that migration of these one or more active tasks to a held or suspended state may allow the representative 104 to better focus on more urgent active tasks for the benefit of the member 110. If the member 110 approves of the proposed migration of one or more active tasks to a held or suspended state in order to reduce the representative's cognitive load, the task selection sub-system 206 may access the task datastore 210 to update one or more entries corresponding to these tasks in order to perform the migration.

If the task selection sub-system 206 determines that one or more active tasks cannot be migrated to a held or suspended state in order to reduce the representative's cognitive load, the task selection sub-system 206 can identify one or more other representatives that may perform the identified one or more active tasks on behalf of the representative 104. For instance, the task selection sub-system 206 may identify one or more representatives whose cognitive load is below the threshold value and who may be able to perform any of the one or more identified active tasks without causing their cognitive load to exceed the threshold value. In an embodiment, the task selection sub-system 206 can determine whether these representatives can perform the one or more active tasks. For instance, the task selection sub-system 206 may use a classification or clustering algorithm configured to identify representatives that may be well-suited to perform certain tasks or categories/types of tasks. These representatives may be profiled based on various criteria, including (but not limited to) demographics and other identifying information, geographic location, experience in handling different categories of tasks, experience in communicating with different categories of members, and the like. Using the classification or clustering algorithm, the task selection sub-system 206 may identify a set of representatives that may be more likely to satisfactorily perform the identified one or more active tasks on behalf of the representative 104.

The task selection sub-system 206 may delegate the identified one or more active tasks to one or more representatives identified as being available to perform these tasks. The task selection sub-system 206 can utilize the task coordination system, as described above, to delegate the identified one or more tasks to the one or more representatives and to allow for coordination of performance of these tasks between the one or more representatives and the representative 104. The task coordination system may allow the representative 104 to monitor performance of the other representatives to which the one or more active tasks have been delegated. The task coordination system may monitor, in real-time, performance of the one or more active tasks by the representative 104 and any other representatives to which one or more active tasks originally assigned to the representative 104 may have been delegated. In some instances, the task coordination system may allow the other representatives to communicate with the member 110 through the task-specific communications sessions corresponding to the one or more active tasks delegated to these other representatives.

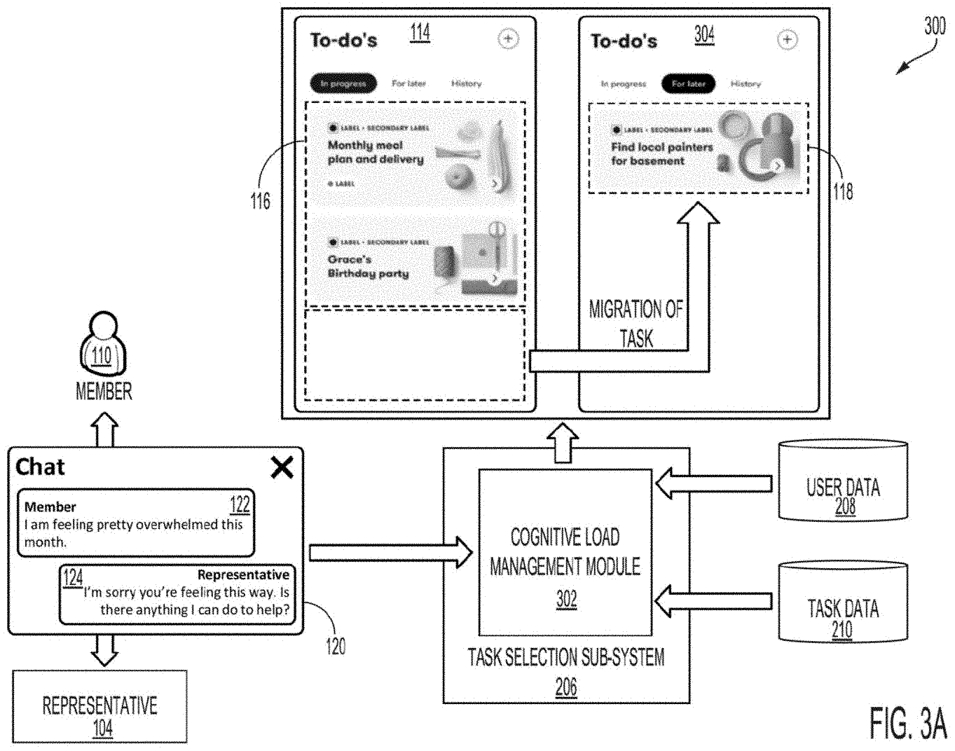

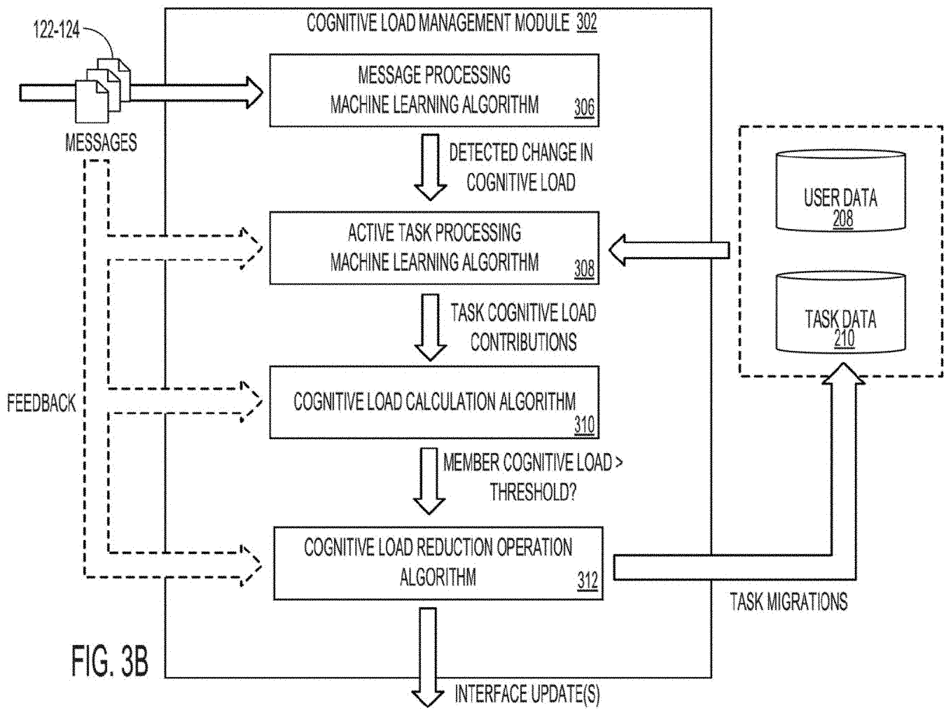

FIGS. 3A-3B show an illustrative example of an environment 300 in which an active task 118 is migrated to a held state as a result of the cognitive load of a member 110 exceeding a threshold in accordance with at least one embodiment. In the environment 300, the task selection sub-system 206 can include a cognitive load management module 302 that can automatically, and in real-time, process messages 122, 124 between a member 110 and an assigned representative 104 as these messages 122, 124 are exchanged over a communications session 120 to detect any changes to a member's or representative's cognitive load and migrate any active tasks to a held or suspended state in the event that the member's or representative's cognitive load exceeds a threshold value. The cognitive load management module 302 may be implemented using a computer system or as an application or other executable code implemented on a computer system of the task selection sub-system 206, as described above. Thus, the cognitive load management module 302 may serve as a component or other functionality of the task selection sub-system 206. The various components of the cognitive load management module 302 are illustrated in greater detail in FIG. 3B. It should be noted that while the cognitive load management module 302 is illustrated in FIG. 3A as processing messages 122, 124 exchanged over the communications session 120, the cognitive load management module 302 may further automatically, in real-time, process any messages exchanged between the member 110 and the representative 104 that are exchanged over any task-specific communications sessions corresponding to any active and held/suspended tasks associated with the member 110.

In an embodiment, the cognitive load management module 302 implements one or more machine learning algorithms or artificial intelligence to determine the cognitive load of the member 110 and of the representative 104 based on messages 122, 124 exchanged over the communications session 120 and/or any other task-specific communications sessions corresponding to any active and held/suspended tasks associated with the member 110. Further, the one or more machine learning algorithms or artificial intelligence may further evaluate any active tasks 116, 118 that may be in progress and presented via an active task interface 114, as described above. For instance, as illustrated in FIG. 3B, the cognitive load management module 302 may implement a message processing machine learning algorithm 306, which may utilize NLP or other artificial intelligence to evaluate these exchanged messages 122, 124 to detect any changes in the member's cognitive load that may be indicative of an increased level of stress and/or of a feeling of being overwhelmed as a result of the active tasks 116, 118 and/or any other factors that may be impacting the member 110. For example, as illustrated in FIG. 3A, the member 110, in a message 122 to the representative 104, has indicated that they are feeling overwhelmed this month. The cognitive load management module 302, using the message processing machine learning algorithm 306, may process this message 122 in real-time and determine that there has been a change in the member's cognitive load. Accordingly, the cognitive load management module 302, using an active task processing machine learning algorithm 308 as illustrated in FIG. 3B, may process the member's active tasks 116, 118 and the detected change in the member's cognitive load based on the message 122 to automatically determine the contribution of each active task to the member's cognitive load and, using a cognitive load calculation algorithm 310 as illustrated in FIG. 3B, determine the member's cognitive load. Further, based on this cognitive load, the cognitive load calculation algorithm 310 can determine whether the member's cognitive load exceeds a threshold value. If so, through a cognitive load reduction operation algorithm 312 as illustrated in FIG. 3B, the cognitive load management module 302 may identify one or more actions that may be performed to reduce the member's cognitive load.

The message processing machine learning algorithm 306, in an embodiment, is an NLP algorithm that is dynamically trained to automatically process, in real-time, communications (e.g., messages 122-124) exchanged between members and representatives through different communications sessions as these messages are exchanged to detect any changes in cognitive load. As used herein, NLP is a mechanism whereby computational systems such as those described herein may be used to process and analyze language (from text and audio sources) that is natural (i.e., unstructured). In such systems, the result of the analysis may enable the message processing machine learning algorithm 306 to generate insights (i.e., information) about the contents of the source communications and, by extension, about other communications that are in the same language. In such systems, the result of the analysis may enable the message processing machine learning algorithm 306 to categorize and/or provide metadata about the source communications and/or about other communications. Being able to both understand and categorize natural language enables the message processing machine learning algorithm 306 to generate better and/or more accurate insights from natural language and may provide a basis for a system that can receive natural language, understand it, and respond in a reasonable manner. As the message processing machine learning algorithm 306 processes and analyzes a larger set of natural language sources, the quality of the understanding and interaction may improve. As an illustrative example, the message processing machine learning algorithm 306 may analyze a large number of communications and may generate an insight that indicates “a communication that frequently uses the phrase ‘I am overwhelmed’ is probably indicative of a negative change to a member's cognitive load.” Examples of NLP algorithms include, but are not limited to, rule-based NLP (also referred to as “symbolic” NLP and based on sets of applied rules), statistical NLP (generally implemented with unsupervised and/or semi-supervised statistical analyses of unstructured data), and Neural NLP (based on representation learning and deep-learning artificial intelligence techniques). As may be contemplated, when analyzing text sources for NLP, systems can directly input the text into the message processing machine learning algorithm 306 while analyzing audio sources may involve first performing speech recognition on the audio source to extract the words and then those words can be input into the message processing machine learning algorithm 306.

As may be contemplated, methods of performing language processing (such as through the message processing machine learning algorithm 306) including, but not limited to, those based on named entity recognition, sentiment analysis, shallow parsing, dependency syntax, semantic role labelling, discourse parsing, and/or semantic parsing as well as techniques based on multilinguality and/or multimodality, may be used to obtain information from the messages 122-124 and/or other such communications (e.g., the communications between the representative 104 and the member 110 described herein) and to provide analysis of those communications to the active task processing machine learning algorithm 308. In some instances, the message processing machine learning algorithm 306 is dynamically trained to provide this analysis to the active task processing machine learning algorithm 308 if the analysis is indicative of a detected change in the member's cognitive load.

The active task processing machine learning algorithm 308 may be dynamically trained using supervised training techniques. For example, to dynamically train the active task processing machine learning algorithm 308, the task facilitation service may generate a dataset comprising various data points corresponding to sample cognitive load contributions for different tasks associated with different members. As an illustrative example of a particular data point that may be included in the training dataset, a data point may include a known cognitive load contribution for a particular task associated with a member, information corresponding to the particular task, and information corresponding to the member for which the task is being performed. Based on this training dataset, the active task processing machine learning algorithm 308 may be dynamically trained to automatically determine the cognitive load contribution of each task assigned to the member 110.

The cognitive load calculation algorithm 310 may be dynamically trained to automatically, and in real-time, aggregate the cognitive load contributions for tasks associated with a member to determine the member's total cognitive load. Based on the member's total cognitive load, the cognitive load calculation algorithm 310 may automatically determine whether the total cognitive load exceeds a pre-defined threshold value. If so, the cognitive load calculation algorithm 310 may automatically transmit the cognitive load contributions provided by the active task processing machine learning algorithm 308, as well as an indication that the member's total cognitive load exceeds the pre-defined threshold value, to the cognitive load reduction operation algorithm 312. In some instances, the cognitive load calculation algorithm 310 may be implemented using one or more classical algorithms or processes that may be executed to perform the aforementioned operations automatically.

The cognitive load reduction operation algorithm 312 may be dynamically trained using supervised techniques. For instance, to dynamically train the cognitive load reduction operation algorithm 312, the task facilitation service may generate a dataset comprising various data points corresponding to a cognitive load associated with a member, a set of active tasks associated with the member, the cognitive load contributions for each of these active tasks, operations performed to reduce the cognitive load (e.g., migration of one or more active tasks to a held or suspended state, etc.), and the resulting cognitive load. As described in greater detail herein, as the cognitive load reduction operation algorithm 312 is used to dynamically, and in real-time, perform various operations to reduce a member's cognitive load, the task facilitation service may use feedback corresponding to the performance of these operations to further train the cognitive load reduction operation algorithm 312. For instance, if a member rejects a migration of a particular task to a held or suspended state (e.g., the member has expressed that the task must be performed within the specified deadline, the member has expressed that the task is to remain active for monitoring purposes, etc.), the task facilitation service may add this feedback to a data point corresponding to the member and their active tasks to indicate that the operations performed by the cognitive load reduction operation algorithm 312 were negatively received. This updated data point may be used in the updated dataset to further retrain the cognitive load reduction operation algorithm 312 as this feedback is received.

The aforementioned machine learning algorithms or artificial intelligence may be implemented within a neural network, whereby the output of the message processing machine learning algorithm 306 may have an impact on the subsequent algorithms implemented by the cognitive load management module 302 (e.g., the active task processing machine learning algorithm 308, the cognitive load calculation algorithm 310, and the cognitive load reduction operation algorithm 312). For example, if the message processing machine learning algorithm 306 determines that there has been no change to the cognitive load of the member 110, the process may end as the status quo may be acceptable (e.g., the active tasks may continue to be performed as the member's cognitive load has not changed since a previous iteration). As another illustrative example, if the cognitive load calculation algorithm 310 determines that a detected change in the member's cognitive load does not rise above a threshold cognitive load value (indicative of a high level of stress or need to reduce the member's cognitive load), the cognitive load calculation algorithm 310 may forego providing the cognitive load values for each of the member's active tasks for the member 110 to the cognitive load reduction operation algorithm 312, thereby ending the process as described above. This neural network may be implemented as a recurrent neural network (RNN), a convolutional neural network (CNN), or other form of neural network.

In an embodiment, the task selection sub-system 206 can utilize a dataset of input messages, active tasks being performed and presented, and corresponding cognitive load from the user datastore 208 and the task datastore 210 to train the machine learning algorithms or other artificial intelligence (e.g., the neural network) utilized by the cognitive load management module 302 to determine the member's cognitive load. As noted above, the machine learning algorithms or artificial intelligence may be evaluated to determine, based on the sample inputs supplied to the machine learning algorithms or artificial intelligence, whether the machine learning algorithms or artificial intelligence are accurately calculating a member's cognitive load based on the sample messages and active tasks provided as input to the machine learning algorithms or artificial intelligence. The machine learning algorithms or artificial intelligence may further be dynamically trained by soliciting feedback from members and representatives of the task facilitation service with regard to the determination of the member's cognitive load. For instance, if the task selection sub-system 206 determines that the machine learning algorithms or artificial intelligence have failed to accurately determine the member's cognitive load given the member's active tasks and messages indicating that the member 110 is overwhelmed or otherwise experiencing a heightened level of stress, the task selection sub-system 206 may use this feedback, along with the corresponding messages submitted by the member 110 indicating that they are overwhelmed or otherwise experiencing a heightened level of stress, as well as parameters corresponding to the member's active tasks, to retrain the machine learning algorithms or artificial intelligence to better determine the member's cognitive load.

Using the aforementioned active task processing machine learning algorithm 308, the cognitive load management module 302 may evaluate, in real-time, the active tasks 116, 118 that are being performed for the benefit of the member 110 and presented via the active task interface 114 to determine their contribution to the member's cognitive load. As noted above, certain tasks may increase the member's cognitive load at a higher rate than other tasks. For instance, urgent or pressing tasks may provide a higher contribution to the member's cognitive load compared to other tasks that may have no clearly defined deadline for completion, are not classified as being urgent, are related to more enjoyable activities or experiences, and the like. In addition to determining the impact of the various active tasks 116, 118 on the member's cognitive load, the active task processing machine learning algorithm 308 may determine the impact of the presentation of these active tasks 116, 118 via the active task interface 114 to the member's cognitive load. The active task processing machine learning algorithm 308 may evaluate, from the user datastore 208, the member profile associated with the member 110 or other member-specific data to determine the member's preferences with regard to the amount of information that may be provided to the member 110 for different tasks and to the number of tasks that may be presented to the member 110 at any given time.

In an embodiment, if the cognitive load management module 302, via the cognitive load calculation algorithm 310, determines that the member's cognitive load exceeds a threshold value and that the number of active tasks 116, 118 being presented via the active task interface 114 exceeds the preferred number indicated by the member 110, the cognitive load management module 302, via a cognitive load reduction operation algorithm 312, can select and remove, in real-time, one or more active tasks from the active task interface 114 and provide the member 110 with an option, via the active task interface 114, to access any other active tasks being performed for the member's benefit. For example, the cognitive load reduction operation algorithm 312 may organize the active tasks 116, 118 according to their contribution to the member's cognitive load and level of urgency for completion (e.g., based on chronological deadline order, level of importance to the member 110, etc.). Thus, the active tasks 116, 118 may be organized such that the more important tasks are presented prominently within the active task interface 114 while other less important active tasks may be accessed via the presented option.

In an embodiment, if the cognitive load reduction operation algorithm 312 determines that the active tasks 116, 118 presented via the active task interface 114 include excess information that the member 110 may not require or otherwise has previously indicated is unnecessary, the cognitive load reduction operation algorithm 312 can automatically and in real-time truncate the excess information provided via the active task interface 114. This may reduce the member's cognitive load by omitting any unnecessary (from the member's perspective) information that may otherwise overwhelm the member 110. The omitted information may still be accessible through selection of an active task from the active task interface 114.

In an embodiment, if the cognitive load management module 302 determines that the member's cognitive load exceeds a threshold value, the cognitive load reduction operation algorithm 312 can select one or more active tasks 118 being performed for the benefit of the member 110 and migrate these one or more active tasks 118 to a held or suspended state. For example, as illustrated in FIG. 3A, the cognitive load management module 302 may migrate an active task 118 from the active task interface 114 to a pending task interface 304, which may include tasks that are designated as being in a held or suspended state for later performance. Alternatively, the cognitive load reduction operation algorithm 312 may reorder the active tasks 116, 118 presented via the active task interface 114 such that the one or more active tasks 118 selected for migration to a held or suspended state are not as prominently presented via the active task interface 114.

The cognitive load management module 302 may automatically select one or more active tasks 118 for migration to a held or suspended state based on one or more factors. For instance, the cognitive load management module 302, using the cognitive load reduction operation algorithm 312, may identify one or more active tasks that may have a lower level of urgency compared to other pending active tasks and that have not been initiated by the representative 104, the member 110, or a third-party service or other service/entity affiliated with the task facilitation service. As another example, the cognitive load management module 302 may identify one or more active tasks that may have a lower priority to the member 110 and, thus, may be delayed for performance at a later time.

If the cognitive load reduction operation algorithm 312 identifies one or more active tasks that may be migrated to a held or suspended state in order to reduce the member's cognitive load, the cognitive load reduction operation algorithm 312 may provide a recommendation to the representative 104 to prompt the member 110 for approval to migrate these identified active tasks 118 to a held or suspended state. The representative 104 may review the recommendation provided by the cognitive load reduction operation algorithm 312 and, via the communications session 120 (such as through one or more messages 124) and/or through task-specific communications sessions corresponding to the identified active tasks 118, prompt the member 110 to approve of the recommended migration of the identified one or more active tasks to a held or suspended state, such that these one or more active tasks may be performed at a later time and such that the member 110 may no longer be prompted with regard to these tasks 118 until they are migrated back to an active state for performance. In some instances, rather than providing the representative 104 with a recommendation to prompt the member 110 for their approval to migrate the identified active tasks to a held or suspended state, the cognitive load reduction operation algorithm 312 can automatically prompt the member 110 via the communications session 120 and/or through the task-specific communications sessions corresponding to the identified active tasks 118 for their approval.

In an embodiment, if the member 110 approves of the migration of the selected active tasks 118 to a held or suspended state, the cognitive load reduction operation algorithm 312 can access the task datastore 210 to update the entries corresponding to these active tasks 118. An entry for a particular task within the task datastore 210 may indicate the present state of the task (e.g., active, held, suspended, completed, etc.). The cognitive load reduction operation algorithm 312 may automatically and in real-time update an entry corresponding to a selected active task to change its state from an “active” state to a “held” or “suspended” state. This may denote that the task is no longer active and is pending subject to later activation. If the task had a corresponding deadline assigned to it, this deadline may be updated to indicate the new state of the task. For instance, the cognitive load reduction operation algorithm 312 may automatically assign a new deadline to the task based on the existing deadlines for the other active tasks 116 being performed for the benefit of the member 110 and the member's cognitive load. In an embodiment, the cognitive load reduction operation algorithm 312 can automatically prompt the member 110 to approve of a new deadline assigned to the task. This may allow the member 110 to determine whether to approve the new deadline proposed by the cognitive load reduction operation algorithm 312, propose a different deadline for the task, or outright reject the new deadline. If the member 110 rejects the new deadline or proposes a different deadline for the task, the cognitive load management module 302 may use this response as feedback with regard to the deadline proposed by the cognitive load reduction operation algorithm 312 that may be used to dynamically retrain the cognitive load reduction operation algorithm 312. Further, if the member 110 rejects the new deadline proposed by the cognitive load management module 302, the cognitive load management module 302 may generate an alternative deadline for the task that may be proposed to the member 110 for the task, thereby repeating the aforementioned process. In some instances, if the member 110 rejects a proposed deadline for the task a set number of times, the cognitive load management module 302 may sustain the original deadline for the task.

In some instances, the cognitive load reduction operation algorithm 312 may automatically review the task within a particular time period before the previously defined deadline for the task (e.g., within two weeks, within a month, etc.). This review may be used to determine whether to return the task to an active state subject to the member's cognitive load. In an embodiment, the automatic review includes transmitting a request to the active task processing machine learning algorithm 308 to determine the cognitive load contributions for each of the active tasks being performed for the benefit of the member 110. As noted above, these cognitive load contributions may be used as input to the cognitive load calculation algorithm 310, which may determine whether the member's cognitive load exceeds a pre-defined threshold. If the member's cognitive load does not exceed this pre-defined threshold, the cognitive load reduction operation algorithm 312 may determine, in real-time, whether migration of a task in the held or suspended state to an active state would result in the member's cognitive load exceeding this pre-defined threshold. If so, the cognitive load reduction operation algorithm 312 may maintain this task in the held or suspended state so as to keep the member's cognitive load below the pre-defined threshold. However, if the cognitive load management module 302 determines that migration of a task in a held or suspended state to an active state would not result in the member's cognitive load exceeding the pre-defined threshold, the cognitive load management module 302 may automatically migrate this task to an active state.

If the cognitive load reduction operation algorithm 312 migrates the selected one or more active tasks 118 to a held or suspended state, the cognitive load management module 302 may notify the representative 104 of the transition. For instance, through a representative console, the cognitive load management module 302 may remove the transitioned tasks from a listing of active tasks that are to be performed for the benefit of the member 110. This may prevent or reduce the likelihood of the representative 104 communicating with the member 110 with regard to these tasks until these tasks are transitioned back to an active state at a later time (e.g., one or more other active tasks are completed, the member's cognitive load is reduced to a particular level, etc.).

As noted above, the cognitive load management module 302 can monitor, in real-time, the messages 122, 124 between the member 110 and the representative 104 as they are exchanged over the communications session 120 to automatically identify the one or more active tasks that may be migrated to a held or suspended state. For instance, the cognitive load management module 302 may process these messages 122, 124, in real-time and as the messages 122, 124 are received, using the aforementioned message processing machine learning algorithm 306 to identify the active tasks that the member 110 would like to transition to a held or suspended state. The cognitive load reduction operation algorithm 312 may automatically transition these active tasks to a held or suspended state or transmit a notification to the representative 104 to prompt the member 110 over the communications session 120 and/or task-specific communications sessions corresponding to these active tasks as to whether the representative 104 or cognitive load management module 302 can migrate these active tasks to a held or suspended state.

Once the identified active tasks have been transitioned to a held or suspended state, the cognitive load management module 302 may automatically, and in real-time, update the active task interface 114 to remove the migrated tasks 118, thereby reducing the number of active tasks 116 presented within the active task interface 114. Further, as noted above, any tasks transitioned to a held or suspended state may be migrated to a pending task interface 304, which may include tasks that are designated as being in a held or suspended state for later performance. In an embodiment, as the active tasks 116 are completed, the cognitive load management module 302, via the cognitive load calculation algorithm 310, can recalculate in real-time the member's cognitive load to determine whether the member 110 can accommodate additional tasks without overwhelming the member 110 or otherwise significantly increasing the member's cognitive load beyond the threshold value. If the cognitive load management module 302 determines that the member 110 can accommodate additional tasks without overwhelming the member 110, the cognitive load reduction operation algorithm 312 may migrate one or more tasks in a held or suspended state to an active state. For instance, the task 118, which may be presented within the pending task interface 304, may be updated to an active state and may be migrated from the pending task interface 304 to the active task interface 114. Further, the cognitive load management module 302 may transmit a notification to the representative 104 to indicate that the task 118 may now be performed for the benefit of the member 110.

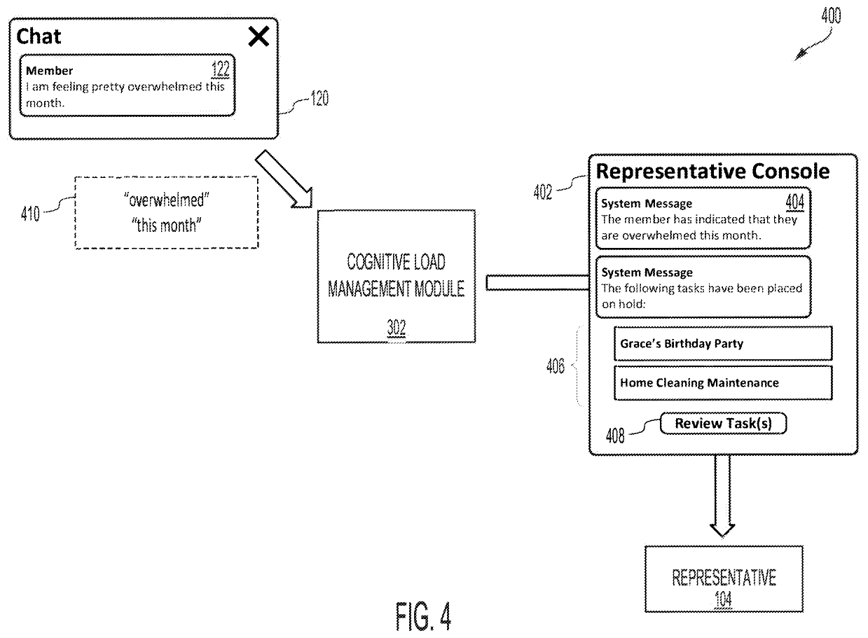

FIG. 4 shows an illustrative example of an environment 400 in which a machine learning algorithm or artificial intelligence is implemented to automatically process, in real-time, messages 122 exchanged between a member and a representative 104 as these messages 122 are exchanged to inform a representative 104 of tasks transitioned to a held state as a result of a change in the cognitive load of the member in accordance with at least one embodiment. As noted above, a member of the task facilitation service and an assigned representative 104 may exchange messages over a communications session 120 or other task-specific communications sessions corresponding to one or more tasks with regard to the performance of these one or more tasks and to otherwise address any issues that may be of concern to the member. For instance, a member may transmit one or more messages 122 over the communications session 120 or other task-specific communications sessions corresponding to any active tasks being performed for the benefit of the member to express that the member is overwhelmed, stressed, tired, or any other emotion that may denote an increase in the member's cognitive load. As illustrated in FIG. 4, the member has expressed that they are feeling overwhelmed over the present month.

In an embodiment, a cognitive load management module 302 of the task selection sub-system described above in connection with FIGS. 2 and 3A-3B may utilize NLP or other artificial intelligence to automatically, and in real-time, process messages exchanged over the communications session 120 and/or other task-specific communications sessions corresponding to any active tasks being performed for the benefit of the member to detect any changes to the member's cognitive load. For instance, as illustrated in FIG. 4, the cognitive load management module 302 may process the message 122 using NLP or other artificial intelligence to identify one or more anchor words or phrases 410 corresponding to a possible change in the member's cognitive load and as to other relevant information that may be used to select active tasks that may be migrated to a held or suspended state to reduce the member's cognitive load. For example, as illustrated in FIG. 4, the cognitive load management module 302 has identified the anchor phrases 410 “overwhelmed” and “this month.” The anchor phrase (or term) “overwhelmed” may correspond to an indication that the member's current cognitive load exceeds a threshold value. The anchor phrase “this month” may correspond to a temporal bound for which the member's cognitive load may be elevated beyond the threshold value. Thus, based on the message 122 expressed by the member indicating that they are overwhelmed in the present month, the cognitive load management module 302 may automatically determine the member's cognitive load and adjust the member's active tasks that are to be performed or are pending in the present month to reduce the member's cognitive load.

In an embodiment, if the cognitive load management module 302 determines that the member's cognitive load has changed based on the messages exchanged between the member and the representative 104 over the communications session 120 and/or other task-specific communications sessions corresponding to any active tasks being performed for the benefit of the member, the cognitive load management module 302 may identify the active tasks currently being performed for the benefit of the member and presented to the member via an active task interface. Further, the cognitive load management module 302 may determine the contribution of each task to the member's cognitive load to determine whether the member's overall cognitive load exceeds a threshold value. If so, the cognitive load management module 302 may select one or more active tasks that may be migrated to a held or suspended state, thereby reducing the number of active tasks that may be performed and presented at a given time. The process for evaluating a member's active tasks and for selecting one or more active tasks that may be migrated to a held or suspended state in order to reduce the member's cognitive load is described in greater detail in connection with FIGS. 3A-3B.

In an embodiment, once the cognitive load management module 302 has selected one or more active tasks that may be migrated to a held or suspended state, the cognitive load management module 302 can transmit a notification to the representative 104 to indicate which one or more active tasks are being migrated to a held or suspended state. For example, as illustrated in FIG. 4, the cognitive load management module 302 may update a representative console 402 utilized by the representative 104 to provide a new message 404 indicating that one or more tasks have been migrated to a held or suspended state in order to reduce the member's cognitive load. The representative console 402 may be implemented as an interface provided by the task facilitation service to representatives associated with the task facilitation service to prompt representatives with regard to available actions or suggestions for managing their relationship with the member. For instance, through the representative console 402, the task facilitation service may provide a representative 104 with information that may assist the representative 104 in communicating with the member in order to assist the member with particular tasks, to ask pertinent questions of the member with regard to performance of tasks, and to indicate when new tasks have been identified and created that are to be performed in order to assist the member with regard to a particular issue expressed by the member. Thus, the representative console 402 may be provided to better guide the representative 104 in assisting the member in order to reduce the member's cognitive load and to better understand the member's needs.

In an embodiment, if the cognitive load management module 302 has identified one or more tasks that may be migrated to a held or suspended state in order to reduce the member's cognitive load, the cognitive load management module 302 can automatically update entries corresponding to these tasks in the aforementioned task datastore to change the state of these tasks from an “active” state to a “held” or “suspended” state, as described above. Further, the cognitive load management module 302 may update the representative console 402 to present these tasks 406 to the representative 104. Through the representative console 402, the representative 104 may review the tasks selected for migration to a held or suspended state. For example, the representative 104 may select a review task button 408 to evaluate each of the selected tasks 406 and determine whether any of these tasks should be returned to an active state and performed for the benefit of the member based on the representative's own knowledge of the member. For instance, if the cognitive load management module 302 has selected a task related to home cleaning maintenance for migration to a held or suspended state, but the representative 104 knows that the member needs to have this task performed in anticipation of an upcoming party that is to be thrown in the member's home, the representative 104 may review this task and indicate that it should be returned to an active state for performance.

In an embodiment, if the representative 104 indicates that one or more selected tasks should be returned to an active state, the cognitive load management module 302 may re-evaluate the member's active tasks and identify one or more other active tasks that may be migrated to a held or suspended state in order to reduce the member's cognitive load. Additionally, or alternatively, the cognitive load management module 302 may identify one or more other techniques that may be implemented to reduce the member's cognitive load. For example, if the cognitive load management module 302 determines that the active tasks presented to the member include excess information that the member may not require or otherwise has previously indicated is unnecessary, the cognitive load management module 302 can truncate the excess information provided to the member. As another example, if the cognitive load management module 302 determines that the number of active tasks being presented to the member exceeds the preferred number indicated by the member, the cognitive load management module 302 can select and remove one or more active tasks from the active task interface and provide the member with an option, via the active task interface, to access any other active tasks being performed for the member's benefit.

In addition to re-evaluating the member's active tasks and identifying one or more other active tasks that may be migrated to a held or suspended state, the cognitive load management module 302 may retrain the machine learning algorithm or artificial intelligence used to select the one or more active tasks for migration to a held or suspended state to reduce the member's cognitive load. As noted above, the machine learning algorithm or artificial intelligence utilized by the cognitive load management module 302 may be dynamically trained by soliciting feedback from members and representatives of the task facilitation service with regard to the determination of the member's cognitive load. Similarly, the response from the representative 104 with regard to the selected tasks 406 for migration to a held or suspended state, and any selection of alternative tasks for migration to a held or suspended state, may be used to dynamically retrain the machine learning algorithm or artificial intelligence. For example, if the representative 104 reverts a selected task to an active state based on the representative's knowledge of the member's preferences and requirements and suggests an alternative task that may be migrated to a held or suspended state, the cognitive load management module 302 may use this feedback to retrain the machine learning module or artificial intelligence to better identify tasks that may be migrated to reduce the member's cognitive load without impacting the member's immediate needs.

As noted above, if the cognitive load management module 302 identifies one or more active tasks that may be migrated to a held or suspended state in order to reduce the member's cognitive load, the cognitive load management module 302 may provide a recommendation to the representative 104, via the representative console 402, to prompt the member for approval to migrate these identified active tasks to a held or suspended state. The representative 104 may review the recommendation provided by the cognitive load management module 302 and, if the representative 104 concurs with the recommendation, prompt the member via the communications session 120 or through other task-specific communications sessions corresponding to the identified one or more active tasks being performed for the benefit of the member to approve of the recommended migration of the identified one or more active tasks to a held or suspended state, such that these one or more active tasks may be performed at a later time and such that the member may no longer be prompted with regard to these tasks until they are migrated back to an active state for performance.

If the member approves of the migration of the identified one or more active tasks to a held or suspended state, the cognitive load management module 302 may complete transition of these identified one or more active tasks to the held or suspended state. Further, the cognitive load management module 302 may notify the representative 104 of the transition. For instance, through the representative console 402, the cognitive load management module 302 may remove the transitioned tasks from a listing of active tasks that are to be performed for the benefit of the member. This may prevent or reduce the likelihood of the representative 104 communicating with the member with regard to these tasks until these tasks are transitioned to an active state at a later time (e.g., one or more other active tasks are completed, the member's cognitive load is reduced to a particular level, etc.).

In an embodiment, if the member does not approve of the migration of the identified one or more active tasks to a held or suspended state, the cognitive load management module 302 may use this rejection of the proposed migration of the identified one or more active tasks as feedback that is used to dynamically retrain the aforementioned machine learning algorithm or artificial intelligence used to identify tasks that may be migrated to a held or suspended state to reduce the member's cognitive load. For example, if the member rejects a selected task for migration to a held or suspended state, the cognitive load management module 302 may use this feedback to dynamically retrain the machine learning module or artificial intelligence to better identify tasks that may be migrated to reduce the member's cognitive load without impacting the member's preferences or needs.

In an embodiment, the cognitive load management module 302 monitors, in real-time, the communications session 120 and/or the task-specific communications session corresponding to the identified one or more active tasks selected for migration to a held or suspended state as messages are exchanged in order to obtain feedback that can be used to dynamically retrain the aforementioned machine learning algorithm or artificial intelligence. For example, the cognitive load management module 302 may utilize NLP or other artificial intelligence to process any messages exchanged through the communications session 120 and/or the task-specific communications session corresponding to the identified one or more active tasks selected for migration to a held or suspended state to determine whether the member approves or rejects the proposed migration of the identified one or more active tasks to a held or suspended state. As an illustrative example, if the member expresses, through a task-specific communications session associated with an identified active task selected for migration, that “This task cannot be pushed back further,” the cognitive load management module 302 may process this message in real-time as the message is exchanged using NLP or other artificial intelligence to detect the member's rejection of this particular active task for migration to a held or suspended state. Accordingly, the cognitive load management module 302 may use this message as feedback to dynamically retrain the machine learning module or artificial intelligence such that, for the member and any other similarly-situated members, the machine learning module or artificial intelligence may better identify tasks that may be migrated to reduce their cognitive load.

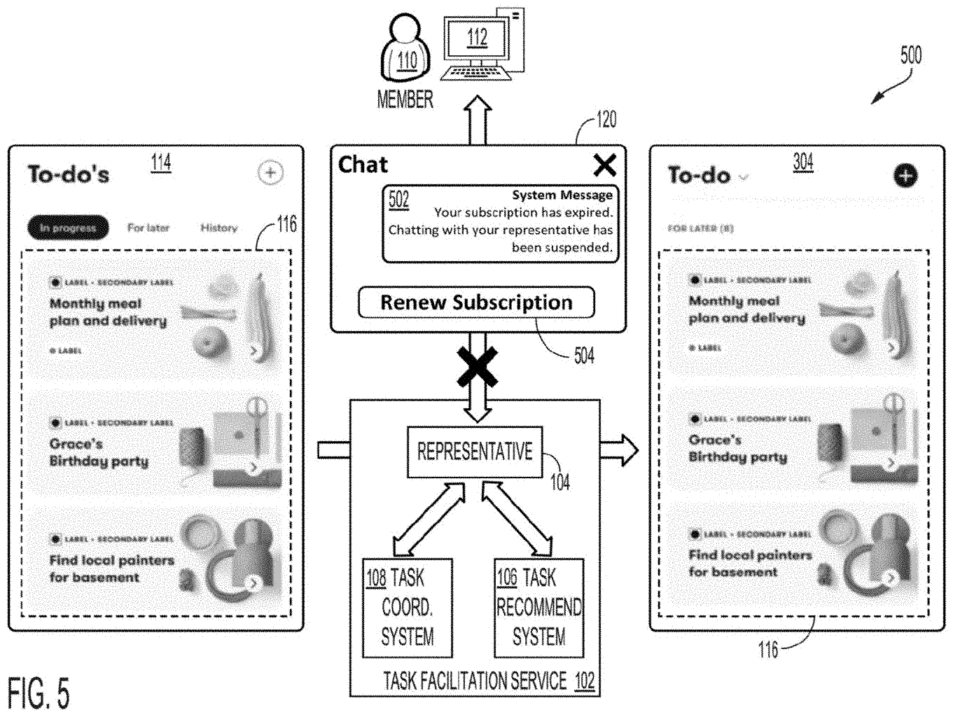

FIG. 5 shows an illustrative example of an environment 500 in which active tasks 116 are automatically migrated to a held state in response to a termination of a member subscription to the task facilitation service 102 in accordance with at least one embodiment. In the environment 500, the task facilitation service 102 automatically detects, in real-time, that a member's subscription to the task facilitation service 102 has been terminated. For instance, a member 110, via an application provided by the task facilitation service 102 and installed on the computing device 112 or through a web portal provided by the task facilitation service 102, may submit a request to the task facilitation service 102 to terminate their subscription to the task facilitation service 102. As another example, the member 110 may allow their subscription to the task facilitation service 102 to lapse (e.g., failure to pay, invalid payment information provided, failure to approve renewal of the subscription, etc.).

In an embodiment, if the task facilitation service 102 determines that the member's subscription has expired or has otherwise been terminated, the task facilitation service 102 can terminate the member's ability to communicate with the representative 104 over the communications session 120 or any of the task-specific communications sessions corresponding to any active tasks associated with the member 110. For instance, the task facilitation service 102 may prevent the member 110 from exchanging messages with the representative 104 over the communications session 120 or the task-specific communications sessions by removing one or more interface elements through which the member 110 may submit these messages. The task facilitation service 102 may continue to provide to the member 110 the ability to review previous conversations with the representative 104 through the communications session 120 the task-specific communications sessions or through the application or web portal provided by the task facilitation service 102.

In an embodiment, the task facilitation service 102, through the task recommendation system 106, automatically migrates any active tasks 116 assigned to the representative 104 or that are otherwise to be performed for the benefit of the member 110 to a held or migrated state until the member 110 renews their subscription to the task facilitation service 102. For instance, the task recommendation system 106 may access a task datastore to update the entries corresponding to the active tasks 116 to change their state from an “active” state to a “held” or “suspended” state. Additionally, the task recommendation system 106 may update the active task interface 114 such that the previously active tasks 116 are no longer presented, thereby indicating that these tasks 116 are no longer in progress and have instead been migrated to the held or suspended state. In some instances, the task recommendation system 106 may migrate the previously active tasks 116 to a pending task interface 304, which may include tasks that are designated as being in a held or suspended state for later performance.

The graphical representation of the tasks 116 added to the pending task interface 304 may be updated to indicate that these tasks 116 have been migrated to a held or suspended state indefinitely until the member 110 renews their subscription to the task facilitation service 102. For example, while tasks presented in the active task interface 114 may be graphically represented using full color, the tasks presented in the pending task interface 304 that are held in a held or suspended state indefinitely may be graphically represented monochromatically. This may allow the member 110 to immediately identify which tasks may be resumed at any time and which are in a held or suspended state indefinitely. It should be noted that other distinguishing features may be used to distinguish active tasks and other tasks that are not held or suspended indefinitely versus other tasks that are held in a held or suspended state indefinitely. For instance, the task recommendation system 106 may assign a label to each task suspended indefinitely to indicate as such.

In an embodiment, if the member's subscription to the task facilitation service 102 is terminated, the task coordination system 108 can transmit a notification to the representative 104 to indicate that progress made on tasks assigned to the representative 104 are suspended until the subscription is renewed. This may cause the representative 104 to terminate performance of any active tasks 116 that are assigned to the representative 104. In some instances, any active tasks assigned to one or more third-party services or other services/entities affiliated with the task facilitation service 102 may continue to be performed through completion, whereby the task coordination system 108 may monitor performance of these one or more third-party services or other services/entities affiliated with the task facilitation service 102 and provide any updates to the member 110. However, the representative 104 may be removed from monitoring of these tasks.

In an embodiment, if the task facilitation service 102 detects that the member's subscription to the task facilitation service 102 has been terminated, the task facilitation service 102 may transmit a message 502 to the member 110 over the communications session 120 to indicate that the subscription has been terminated and that further communication with the representative 104 has been suspended. Further, the task facilitation service 102 may provide, through the communications session 120, a renew subscription button 504, through which the member 110 may submit a request to the task facilitation service 102 to renew their subscription. In some instances, the task facilitation service 102 may further transmit the message 502 to the member 110 over the task-specific communications sessions corresponding to the tasks migrated to a held or suspended state as a result of the subscription having been terminated. Through these task-specific communications sessions, the task facilitation service 102 may further provide a renew subscription button 504. Thus, the member 110 may determine, from any communications session made available to the member 110, that the subscription has been terminated, that further communication with the representative 104 has been suspended, and whether to renew the subscription in order to resume communication with the representative 104 and/or performance of the held or suspended tasks. In some instances, the member 110 may transmit one or more messages over the communications session 120 or any of the task-specific communications sessions to indicate that they would like to renew their subscription to the task facilitation service 102. Thus, the task facilitation service 102 may detect a request to renew the member's subscription through selection of the renew subscription button 504 or through processing of a member's messages indicating such a request.

In an embodiment, if the member 110 submits a request to the task facilitation service 102 to renew their subscription to the task facilitation service 102, the task facilitation service 102 may attempt to assign the representative 104 previously assigned to the member 110 prior to termination of the subscription to the member 110. For instance, the task facilitation service 102 may determine whether the representative 104 is available for assignment to the member 110 (e.g., the representative 104 is not assigned to a maximum number of other members, the representative's cognitive load is not above a threshold value, etc.). If the representative 104 is unavailable (e.g., the representative 104 is already engaged with one or more other members, etc.), the task facilitation service 102 may select another representative based on the member profile associated with the member 110 and the parameters of the tasks 116 maintained in the held or suspended state. For instance, task facilitation service 102 may rank each representative of a set of available representatives according to degrees or vectors of similarity between the member's and representative's demographic information. Each factor, in some instances, may be weighted based on the impact of the factor on the creation of a positive, long-term relationship between members and representatives. For instance, based on historical data corresponding to member interactions with representatives, task facilitation service 102 may identify correlations between different factors and the polarities of these interactions (e.g., positive, negative, etc.). Based on these correlations (or lack thereof), task facilitation service 102 may apply a weight to each factor.

In some instances, each representative of the identified set of available representatives may be assigned a score corresponding to the various factors corresponding to the degrees or vectors of similarity between the member's and representative's demographic information. For instance, each factor may have a possible range of scores corresponding to the weight assigned to the factor. However, based on the weight assigned to each factor, the possible score may be multiplied by a weighting factor such that a factor having greater weight may be multiplied by a higher weighting factor compared to a factor having a lesser weight. The result is a set of different scoring ranges corresponding to the importance or relevance of the factor in determining a match between a member and a representative. The scores determined for the various factors may be aggregated to obtain a composite score for each representative of the set of representatives. These composite scores may be used to create the ranking of the set of representatives. In an embodiment, the task facilitation service 102 uses the ranking of the set of representatives to select a representative that may be assigned to the member 110.

If the member 110 renews their subscription to the task facilitation service 102, the task recommendation system 106 may migrate one or more of the tasks 116 from the held or suspended state to an active state. In some instances, the task recommendation system 106 may determine the contribution of each task 116 to the member's cognitive load and identify which tasks may be migrated to an active state without overwhelming the member 110 or otherwise increasing the member's cognitive load beyond a threshold value. The process for determining the contribution of each task 116 to the member's cognitive load is described herein in connection with FIGS. 1-4 and 7. The task recommendation system 106 may further migrate the one or more tasks 116 from the pending task interface 304 to the active task interface 114. This may indicate to the member 110 that these tasks are now being performed for their benefit.

The task recommendation system 106, through the task coordination system 108, may transmit a notification to the assigned representative (whether representative 104 or a different representative assigned to the member 110 by the task facilitation service 102) to indicate that the one or more tasks 116 migrated to an active state have now been assigned to the representative for performance. For instance, via a representative console, the task coordination system 108 may provide the newly active tasks 116 to the representative for performance.

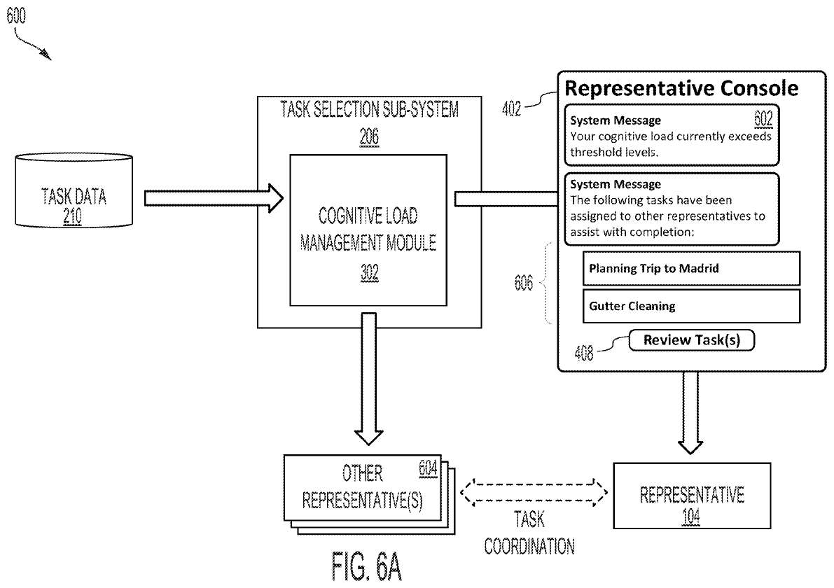

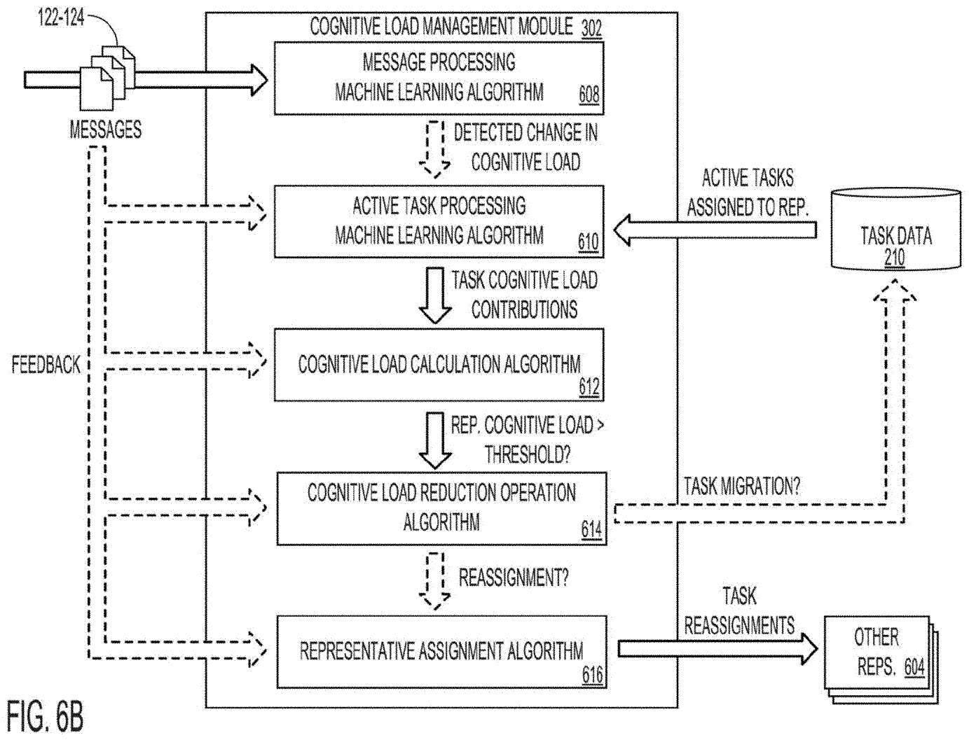

FIGS. 6A-6B show an illustrative example of an environment 600 in which machine learning algorithms or artificial intelligence are implemented to automatically re-assign one or more active tasks to other representatives 604 as a result of a change in the cognitive load of the representative 104 in accordance with at least one embodiment. In the environment 600, the cognitive load management module 302 of the task selection sub-system 206 may determine the cognitive load of the representative 104 and determine whether one or more actions are to be performed to reduce the representative's cognitive load. For instance, from the task datastore 210, the cognitive load management module 302, using an active task processing machine learning algorithm 608, may obtain the active tasks assigned to the representative 104 that are to be performed for the benefit of the members to which the representative 104 is assigned to. The cognitive load management module 302 may process these active tasks using the active task processing machine learning algorithm 608 to determine the contribution of each of these active tasks to the representative's cognitive load. The active task processing machine learning algorithm 608 may be similar to, or the same as, the active task processing machine learning algorithm 308 described above in connection with FIGS. 3A-3B.

Similar to how certain tasks may increase a member's cognitive load at a higher rate than other tasks, different tasks may impact the representative's cognitive load at different rates. For instance, tasks that require active representative participation and/or require more steps or actions to complete may contribute to a higher cognitive load than simpler tasks or tasks that are primarily performed by one or more third-party services but are otherwise monitored by the representative 104. Further, certain types or categories of tasks may contribute to a higher representative cognitive load compared to other types or categories of tasks. For example, tasks related to a move to a new location may require significant coordination and monitoring, which may result in a higher cognitive load compared to tasks related to simple maintenance tasks, such as gutter cleaning or oil changes.

In some instances, the cognitive load management module 302 may use a message processing machine learning algorithm 608 (which may be similar to, or the same as, the message processing machine learning algorithm 306 described above in connection with FIGS. 3A-3B) to process messages exchanged between a member and the representative 104 over a communications session to detect a change in the representative's cognitive load. The message processing machine learning algorithm 608 may be an NLP algorithm that is configured to process messages 122-124 in real-time between a member and a representative as these messages 122-124 are exchanged over a communications session. In an example, if during the communications session a member seeks to obtain an update with regard to an active task and the representative 104 indicates, in response to the member's request for an update, that the representative 104 is overwhelmed or that they are trying to complete other active tasks before beginning work on the active task indicated by the member, the message processing machine learning algorithm 608 may detect a possible change to the representative's cognitive load that may warrant a re-evaluation of the active tasks assigned to the representative 104.

If the message processing machine learning algorithm 608 detects a change in the representative's cognitive load, the message processing machine learning algorithm 608 may output an indication of this change to the active task processing machine learning algorithm 610 of the cognitive load management module 302. The active task processing machine learning algorithm 610 as illustrated in FIG. 6B may process the active tasks assigned to the representative from the task datastore 210 and the detected change in the representative's cognitive load based on the messages 122, 124 to automatically determine the contribution of each active task to the representative's cognitive load and, using a cognitive load calculation algorithm 612 as illustrated in FIG. 6B, determine the representative's overall cognitive load. The cognitive load calculation algorithm 612 may be similar to, or the same as, the cognitive load calculation algorithm 310 described above in connection with FIGS. 3A-3B.

In an embodiment, if the cognitive load management module 302 determines that the representative's cognitive load exceeds a threshold value, the cognitive load management module 302, via a cognitive load reduction operation algorithm 614, can perform one or more actions to reduce the representative's cognitive load. For example, the cognitive load reduction operation algorithm 614 may determine whether one or more active tasks assigned to the representative 104 can be migrated to a held or suspended state such that the number of active tasks that are assigned to the representative 104 is reduced. The one or more active tasks that may be migrated to a held or suspended state may be selected based on one or more factors. For instance, the cognitive load reduction operation algorithm 614 may identify one or more active tasks that may have a lower level of urgency compared to other pending active tasks and that have not been initiated by the representative 104 or a third-party service. As another example, the cognitive load reduction operation algorithm 614 may identify one or more active tasks that may have a lower priority to corresponding members and, thus, may be delayed for performance at a later time. The cognitive load reduction operation algorithm 614 may be similar to, or the same as, the cognitive load reduction operation algorithm 312 described above in connection with FIGS. 3A-3B.

In an embodiment, if the cognitive load reduction operation algorithm 614 identifies one or more active tasks that can be migrated to a held or suspended state to reduce the representative's cognitive load, the cognitive load reduction operation algorithm 614 can provide a recommendation to the representative 104 to communicate with corresponding members to obtain these members' approval for migration of these active tasks to the held or suspended state. For example, via a representative console 402, the cognitive load reduction operation algorithm 614 may transmit one or more messages 602 indicating that the representative's cognitive load currently exceeds threshold levels and that one or more assigned active tasks may be migrated to a held or suspended state subject to member approval. The cognitive load reduction operation algorithm 614, through these one or more messages 602, may further provide the representative 104 with one or more recommended messages that may be exchanged with corresponding members to increase the likelihood of member approval for migration of the identified active tasks to a held or suspended state. For example, the recommendation provided by the cognitive load reduction operation algorithm 614 may instruct the representative 104 to indicate that migration of these one or more active tasks to a held or suspended state may allow the representative 104 to better focus on more urgent active tasks for the benefit of the corresponding members.

If a member approves of a proposed migration of one or more active tasks to a held or suspended state, the cognitive load management module 302, using the cognitive load reduction operation algorithm 614, may access the task datastore 210 to update the entries corresponding to these one or more active tasks. As noted above, an entry for a particular task within the task datastore 210 may indicate the present state of the task (e.g., active, held, suspended, completed, etc.). The cognitive load reduction operation algorithm 614 may update an entry corresponding to a selected active task to change its state from “active” to a “held” or “suspended” state. This may denote that the task is no longer active and is pending subject to later activation. If the task had a corresponding deadline assigned to it, this deadline may be updated to indicate the new state of the task. Alternatively, the cognitive load reduction operation algorithm 614 may automatically review the task within a particular time period before the previously defined deadline for the task (e.g., within two weeks, within a month, etc.). Once an active task has been migrated to a held or suspended state, the cognitive load reduction operation algorithm 614 may update the representative console 402 to remove this task from the set of active tasks currently assigned to the representative 104.

In an embodiment, if the cognitive load reduction operation algorithm 614 determines that one or more active tasks selected for migration cannot be migrated to a held or suspended state (e.g., a member has rejected a recommendation to migrate a task, a task is considered urgent or critical to a member's needs, etc.), the cognitive load reduction operation algorithm 614 may transmit an indication that reassignment of the task to another representative may be necessary. This indication may be received by a representative assignment algorithm 614, which may identify one or more other representatives 604 that may be able to perform these identified tasks on behalf of the representative 104 without negatively impacting corresponding members. For instance, the representative assignment algorithm 616 may automatically evaluate the active tasks assigned to each other representative 604 to determine the cognitive load of each of these other representatives 604. Based on this evaluation, the representative assignment algorithm 616 may identify one or more other representatives 604 that may be available to perform the identified one or more active tasks on behalf of the representative 104.

In an embodiment, once the representative assignment algorithm 616 has identified one or more other representatives 604 that may perform the identified one or more active tasks on behalf of the representative 104, the representative assignment algorithm 616 can evaluate each of these other representatives 604 to determine whether these representatives 604 can perform the one or more active tasks (e.g., are experienced in performing such tasks, have worked with similarly-situated members with regard to similar tasks, etc.). The representative assignment algorithm 616 may be a classification or clustering algorithm, as described above, that may be used to identify any representatives that may be well-suited to perform certain tasks or categories/types of tasks. For instance, these other representatives 604 may be profiled based on various criteria, including (but not limited to) demographics and other identifying information, geographic location, experience in handling different categories of tasks, experience in communicating with different categories of members, and the like. Using the classification or clustering algorithm, the cognitive load management module 302 may identify a set of representatives 604 that may be more likely to perform the identified one or more active tasks on behalf of the representative 104 in a satisfactory manner.

If the representative assignment algorithm 616 identifies one or more other representatives 604 that may perform the identified one or more active tasks on behalf of the representative 104, the representative assignment algorithm 616 may delegate these one or more active tasks to the one or more other representatives 604. In an embodiment, the cognitive load management module 302 can use the task coordination system (as described above in connection with FIGS. 1-2) to delegate the identified one or more tasks to the one or more other representatives 604 and to allow for coordination of performance of these active tasks between the one or more representatives and the representative 104. The task coordination system may allow the representative 104 to monitor performance of the other representatives 604 to obtain any updates with regard to the one or more delegated tasks and to provide any information or feedback with regard to the performance of these other representatives 604 in performing the one or more active tasks. In some instances, the task coordination system may establish a communications session between the representative 104 and the other representatives 604 selected by the cognitive load management module 302 to allow the representative 104 to monitor performance of the one or more active tasks and to provide any insights that may assist these other representatives 604 in performing the one or more active tasks.

In an embodiment, once an active task has been delegated to another representative 604, the cognitive load management module 302 may transmit one or more messages 602 to the representative 104 indicating this delegation of the active task. For example, as illustrated in FIG. 6A, the cognitive load management module 302 may transmit one or more messages 602 to the representative 104 via the representative console 402 to indicate that one or more active tasks 606 have been assigned to other representatives 604 in order to assist the representative 104 with completion of these tasks 606 and to reduce the representative's cognitive load. Through the representative console 402, the representative 104 may be presented with the active tasks 606 delegated to other representatives 604. Further, the representative 104, via the representative console 402, may review the active tasks 606 that have been delegated to other representatives 604. For example, the representative 104 may select a review task button 408 to evaluate each of the active tasks 606 delegated to other representatives 604 and determine whether any of these tasks 606 should be reassigned to the representative 104 based on the representative's own knowledge of the member and/or of the active task. For instance, if the cognitive load management module 302 has selected a task related to lawn maintenance for delegation to another representative, but the representative 104 knows that the member needs to have this task performed in conjunction with another active task being performed by the representative 104 related to patio installation, the representative 104 may review this active task and indicate that it should be reassigned to the representative 104. Alternatively, the representative 104 may communicate with the other representative selected for the active task to provide any additional instructions or information that may be used by the other representative to perform the active task without interfering with any other related tasks being performed by the representative 104.

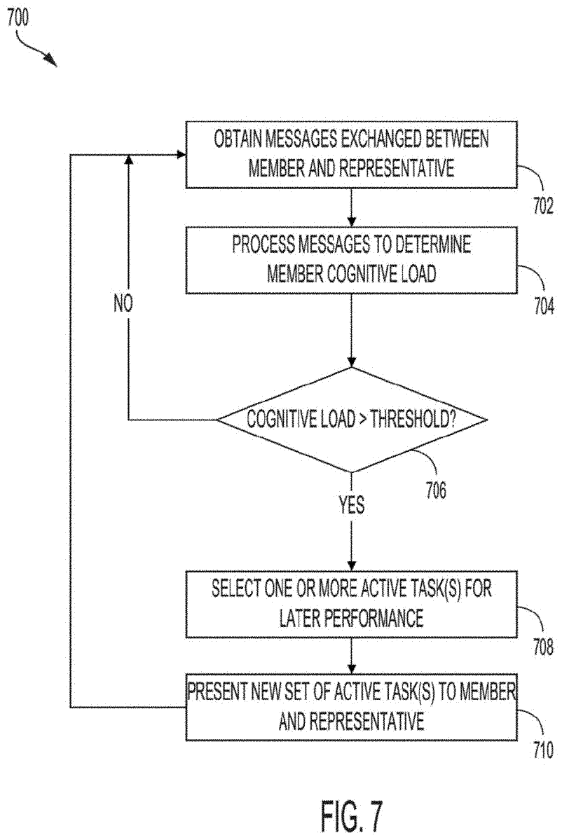

FIG. 7 shows an illustrative example of a process 700 for transitioning one or more active tasks to a held state for later performance as a result of the cognitive load of a member exceeding a threshold in accordance with at least one embodiment. The process 700 may be performed by a task selection sub-system of the task recommendation system. As noted above, the task selection sub-system may implement a cognitive load management module, which may include machine learning algorithms or artificial intelligence that may be used to dynamically, and in real-time, process messages between a member and a representative as these messages are exchanged, as well as any active tasks being performed for the benefit of the member, to automatically determine the member's cognitive load and to take any appropriate action should the member's cognitive load exceed a threshold value. As such, the process 700 may be performed using, at least in part, the cognitive load management module.

At step 702, the task selection sub-system obtains messages between a member and an assigned representative as these messages are being exchanged. For instance, the task selection sub-system may maintain a data stream or feed through which messages exchanged between the member and the representative are transmitted to the task selection sub-system automatically and in real-time. Alternatively, the task selection sub-system may actively monitor the communications session between the member and the representative to obtain any newly exchanged messages in real-time.

At step 704, the task selection sub-system can process the messages exchanged over the communications session between the member and the representative in real-time and as these messages are exchanged to determine the member's cognitive load. As noted above, the task selection sub-system may use NLP or other artificial intelligence to process the messages exchanged between the member and the representative over the communications session to determine whether there has been a change to the member's cognitive load that may warrant further evaluation of active tasks being performed for the benefit of the member and presented to the member via an active task interface. If the task selection sub-system determines, based on the exchanged messages, that the member's cognitive load may have changed and warrants further review of the active tasks being performed for the benefit of the member and presented to the member via an active task interface, the task selection sub-system may evaluate the active tasks that are being performed for the benefit of the member to determine their contribution to the member's cognitive load. Further, in addition to determining the impact of the various active tasks on the member's cognitive load, the task selection sub-system may determine the impact of the presentation of these active tasks via an active task interface to the member's cognitive load.

Based on the processing of the exchanged messages between the member and the representative over the communications session, as well as on an evaluation of the active tasks being performed for the benefit of the member and presented to the member via the active task interface, the task selection sub-system, at step 706, may determine whether the member's cognitive load exceeds a threshold value. If the task selection sub-system determines that the member's cognitive load does not exceed this threshold value, the task selection sub-system may continue to monitor the communications session to process any new messages exchanged between the member and the representative in real-time and as these messages are being exchanged, thereby restarting the process 700.

If the task selection sub-system determines, based on its processing of the exchanged messages between the member and the representative, as well as of the active tasks being performed for the benefit of the member and presented to the member via the active task interface, that the member's cognitive load exceeds the threshold value, the task selection sub-system, at step 708, may select one or more active tasks for migration to a held or suspended state, whereby the selected one or more active tasks may be performed at a later time. The task selection sub-system may select the one or more active tasks that may be migrated to a held or suspended state based on one or more factors. For instance, the task selection sub-system may identify one or more active tasks that may have a lower level of urgency compared to other pending active tasks and that have not been initiated by the representative, the member, or a third-party service. As another example, the task selection sub-system may identify one or more active tasks that may have a lower priority to the member and, thus, may be delayed for performance at a later time. In some instances, the task selection sub-system may provide a recommendation to the representative to prompt the member for approval to migrate one or more active tasks to a held or suspended state. The representative may review the recommendation provided by the task selection sub-system and prompt the member to approve the recommended migration of the identified one or more active tasks to a held or suspended state. In some instances, rather than providing the representative with a recommendation to prompt the member for their approval to migrate the identified active tasks to a held or suspended state, the task selection sub-system can automatically prompt the member via the communications session for their approval. If the member approves of the migration of the identified one or more active tasks to a held or suspended state, the task selection sub-system may transition these identified one or more active tasks to the held or suspended state.

At step 710, once the task selection sub-system has obtained approval from the member for the migration of the identified one or more active tasks (if approval is required), the task selection sub-system may present the new set of active tasks to the member and the representative. This new set of active tasks may omit any of the previously identified tasks that have been migrated to a held or suspended state. In some instances, the task selection sub-system may update the active task interface to remove the migrated tasks while maintaining the other active tasks that may be performed for the benefit of the member. This may reduce the number of tasks presented via the active task interface and, thus, reduce the member's cognitive load and may reduce the number of tasks that the member may need to track or monitor performance of at the given time. As these active tasks are performed, the task selection sub-system may continue to monitor the communications session to process any new messages exchanged between the member and the representative in real-time and as these messages are being exchanged, thereby restarting the process 700.

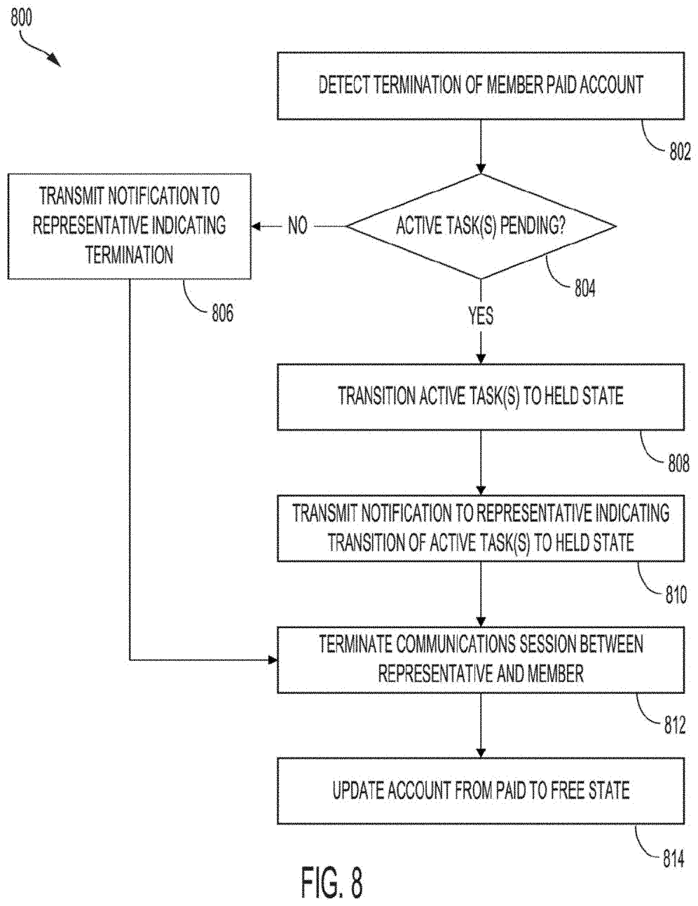

FIG. 8 shows an illustrative example of a process 800 for transitioning one or more active tasks to a suspended state as a result of termination of a member subscription to the task facilitation service in accordance with at least one embodiment. The process 800 may be performed by the task facilitation service in conjunction with the aforementioned task recommendation system, which may migrate active tasks to a held or suspended state upon termination of a member subscription.

At step 802, the task facilitation service may detect termination of a member's paid account. In order the member to interact with a representative and to have the representative perform one or more tasks on behalf of the member, the member may be required to maintain a paid account with the task facilitation service. The member, at any time or subject to one or more contractual limitations, may submit a request to terminate their paid account with the task facilitation service. For instance, via an application provided by the task facilitation service and installed on the member's computing device, the member may submit a request to the task facilitation service to terminate their paid account with the task facilitation service. In some instances, a member can allow their paid account with the task facilitation service to lapse, such as through failure to continue payment for the account, failure to update or provide valid payment information, failure to respond to a prompt to renew their account, and the like. Based on any of these events, the task facilitation can detect the termination of the member's paid account.

At step 804, the task facilitation service may determine whether the member had any active tasks pending or being performed on their behalf. For instance, the task facilitation service may evaluate the member's account to determine whether any active tasks are present and currently being performed by the assigned representative. If the task facilitation service determines that there are no active tasks being performed for the benefit of the member, the task facilitation service, at step 806, may transmit a notification to the assigned representative to indicate that the member's paid account has been terminated. This notification may cause the representative to terminate the communications session between the member and the representative. Alternatively, the task facilitation service, at step 812, may automatically terminate the member's ability to communicate with the representative over the communications session. For instance, the task facilitation service may prevent the member from exchanging messages with the representative over the communications session by removing one or more interface elements through which the member may submit these messages. The task facilitation service may continue to provide to the member the ability to review previous conversations with the representative through the communications session or through the application provided by the task facilitation service.

If the task facilitation service determines that the member has one or more active tasks pending (e.g., being performed by a representative previously assigned to the member), the task facilitation service may utilize the task recommendation system, at step 808, to automatically transition these one or more active tasks to a held or suspended state. For instance, the task recommendation system may access a task datastore to update the entries corresponding to the active tasks to change their state from “active” to a “held” or “suspended” state. Additionally, the task recommendation system may update the active task interface (e.g., active task interface 114 described above in connection with FIGS. 1, 3, and 5) such that the previously active tasks are no longer presented, thereby indicating that these tasks are no longer in progress and are instead held in the held or suspended state. As noted above, the task recommendation system may migrate the previously active tasks to a pending task interface (e.g., pending task interface 304 described above in connection with FIGS. 3A-3B and 5), which may include tasks that are designated as being in a held or suspended state for later performance.

At step 810, the task facilitation service may transmit a notification to the representative assigned to the member to indicate that these active tasks have been transitioned to a held or suspended state. This notification may further indicate that progress made on tasks assigned to the representative are suspended until the paid account is renewed. This may cause the representative to terminate performance of any active tasks that are assigned to the representative. In some instances, any active tasks assigned to one or more third-party services may continue to be performed through completion, whereby the task coordination system may monitor performance of these one or more third-party services and provide any updates to the member. However, the representative may be removed from monitoring of these tasks. This notification may further cause the representative to terminate the communications session between the member and the representative. Alternatively, the task facilitation service, at step 812, may automatically terminate the member's ability to communicate with the representative over the communications session, as described above.

At step 814, the task facilitation service may update the member's account from a paid state to a free state. The member may continue to utilize the application provided by the task facilitation service to review any pending tasks being performed by one or more third-party services and any other tasks that are being performed by the member themselves. Further, the member may use the application to create new tasks. However, these new tasks may not be provided to a representative or to a third-party for performance. As such, these new tasks, by default, may be placed in a held or suspended state until the member renews their paid account. As noted above, the member may further use the application to review any previous conversations with the representative through the now terminated communications session.

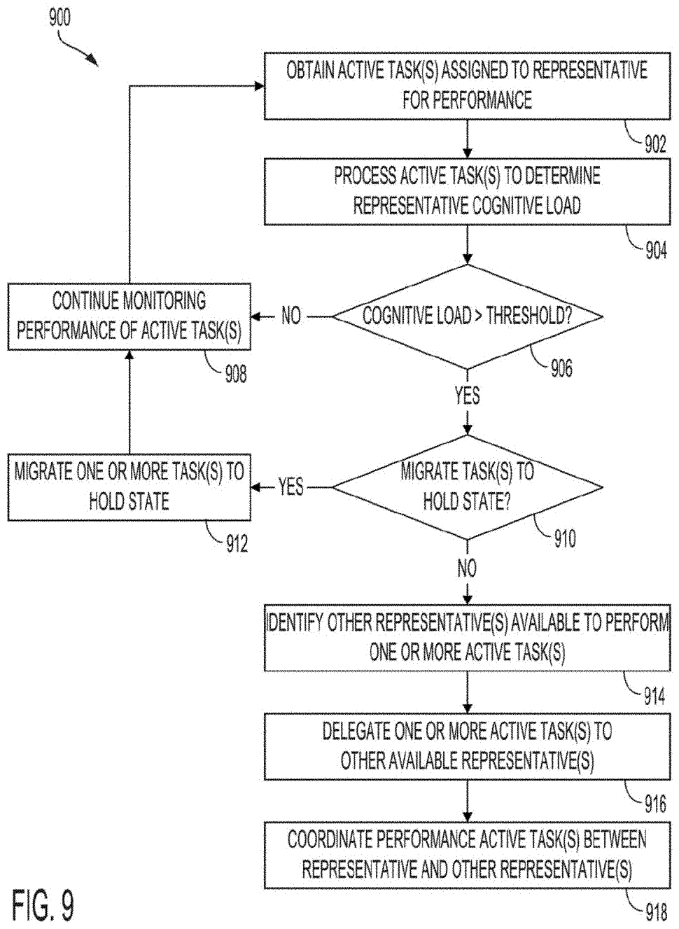

FIG. 9 shows an illustrative example of a process 900 for reducing the cognitive load of a representative as a result of the cognitive load of the representative exceeding a threshold in accordance with at least one embodiment. Similar to the process 700 described above in connection with FIG. 7, the process 900 may be performed by a task selection sub-system of the task recommendation system, which may implement a cognitive load management module that includes one or more machine learning algorithms or artificial intelligence that may be used to dynamically, and in real-time, determine the representative's cognitive load and to take any appropriate action should the representative's cognitive load exceed a threshold value.

At step 902, the task selection sub-system may obtain the set of active tasks currently assigned to a representative for performance. For instance, the task selection sub-system may access a task datastore to identify any active tasks that are currently assigned to the representative and that are to be performed for the benefit of one or more members. These active tasks may be presented to the representative via a representative console, as described above in connection with at least FIG. 4. The task selection sub-system may obtain the set of active tasks assigned to the representative periodically, in response to a triggering event, or as new active tasks are assigned to the representative for performance. For example, the task selection sub-system may use NLP or other artificial intelligence process messages exchanges between members of the task facilitation service and the representative to detect a change in the representative's cognitive load. For example, if during a communications session the representative indicates that they are overwhelmed or that they are trying to complete other active tasks before beginning work on an active task indicated by a member, the task selection sub-system may detect a change in the representative's cognitive load that may warrant an evaluation of the active tasks assigned to the representative.

At step 904, the task selection sub-system may process the active tasks assigned to the representative to determine the representative's cognitive load. As noted above, certain tasks may increase the representative's cognitive load at a higher rate than other tasks. For example, tasks that require active representative participation and/or require more steps or actions to complete may contribute to a higher cognitive load than simpler tasks or tasks that are primarily performed by one or more third-party services but are otherwise monitored by the representative. Further, certain types or categories of tasks may contribute to a higher representative cognitive load compared to other types or categories of tasks. Thus, based on an evaluation of these active tasks, the task selection sub-system may determine each task's contribution to the representative's cognitive load. Further, in addition to determining the impact of the various active tasks on the representative's cognitive load, the task selection sub-system may determine the impact of the presentation of these active tasks via the representative console to the representative's cognitive load.

Based on the processing of the active tasks assigned to the representative and of the messages exchanged between the representative and the members to which the representative is assigned to, the task selection sub-system, at step 906, may determine whether the representative's cognitive load exceeds a threshold value. If the task selection sub-system determines that the representative's cognitive load does not exceed this threshold value, the task selection sub-system, at step 908, may continue to monitor the active tasks assigned to the representative and the communications exchanged between the representative and the members assigned to the representative to evaluate the representative's cognitive load, thereby restarting the process 900.

If the representative's cognitive load exceeds a threshold value, the task selection sub-system, at step 910, may determine whether to migrate one or more active tasks assigned to the representative to a held or suspended state. As noted above, the task selection sub-system can provide a recommendation to the representative to communicate with any member whose active tasks have been identified for migration in order to obtain the member's approval to migrate these active tasks to the held or suspended state. The task selection sub-system may provide the representative with a recommendation corresponding to one or more messages that may be exchanged by the representative over a communications session to obtain a member's approval for migrating an identified task to a held or suspended state.

If a member indicates that they approve of the proposed migration of an active task to a held or suspended state, or if migration may be performed without member approval, the task selection sub-system, at step 912, may migrate the active task to the held or suspended state. As noted above, the task selection sub-system can update an entry corresponding to the active task in the task datastore to migrate the task from an active state to a held or suspended state. Further, the task selection sub-system may update the active task interface utilized by the member to review any active tasks to omit the migrated task. In some instances, the task selection sub-system may also update the representative console utilized by the representative to remove the migrated task from the set of active tasks that are either being performed by the representative or are scheduled for performance. The task selection sub-system, at step 908, may continue monitoring of the representative's performance of the other active tasks and of the representative's cognitive load, thereby restarting the process 900.

If the task selection sub-system determines that the identified active tasks cannot be migrated to a held or suspended state (e.g., a member has rejected a recommendation to migrate one or more active tasks to a held or suspended state, the active tasks are urgent or critical to a member, etc.), the task selection sub-system, at step 914, can identify one or more other representatives that may be available to perform the one or more active tasks on behalf of the representative. For instance, the task selection sub-system may determine the cognitive load of the various representatives associated with the task facilitation service to identify one or more representatives whose cognitive load is below the threshold value and who may be able to perform any of the one or more identified active tasks without causing their cognitive load to exceed the threshold value. As noted above, the task selection sub-system can evaluate each of the identified representatives to determine whether these representatives are sufficiently experienced or otherwise capable of performing the one or more active tasks.

At step 916, the task selection sub-system may delegate these one or more active tasks to the identified one or more other representatives. Further, at step 918, the task selection sub-system may coordinate performance of these active tasks between the representative and the identified representatives. For instance, the task selection sub-system can utilize a task coordination system to delegate the identified one or more tasks to the identified representatives and to allow for coordination of performance of these tasks between the one or more representatives and the representative. The task coordination system may allow the representative to monitor performance of the other representatives to which the one or more active tasks have been delegated. For instance, the task coordination system may establish a communications session between the representative and the other representatives selected by the task selection sub-system to allow the representative to monitor performance of the one or more active tasks and provide any insights that may assist these other representatives in performing the one or more active tasks. This may also allow the representative to provide updates to members with regard to the performance of their one or more active tasks.

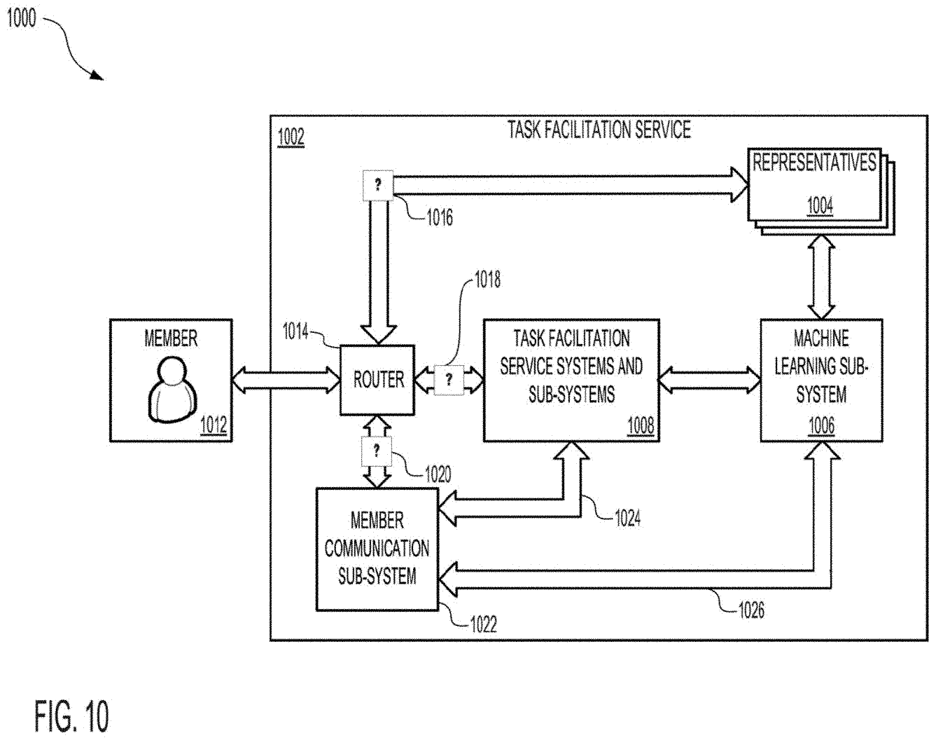

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

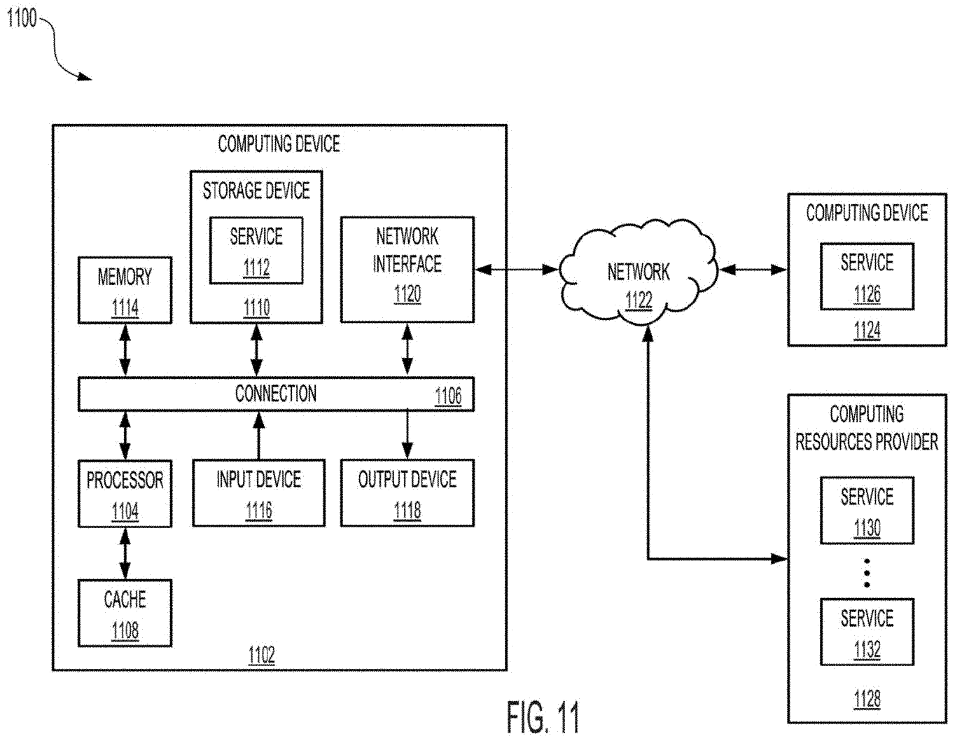

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6A-6B and FIGS. 7-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving in real-time a set of messages between a member and a representative as the set of messages are being exchanged;
automatically detecting an indication of a cognitive load change associated with the member, wherein the indication is automatically detected based on the set of messages;
determining a cognitive load associated with the member, wherein the cognitive load is determined in response to the cognitive load change, and wherein the cognitive load is determined based on a set of active tasks being performed for the member, a presentation of the set of active tasks, and the set of messages;
determining that the cognitive load of the member exceeds a threshold;
dynamically selecting one or more active tasks of the set for migration to a suspended state, wherein the one or more active tasks are selected using a trained machine learning algorithm, and wherein the trained machine learning algorithm uses a profile corresponding to the member, the set of active tasks, and the cognitive load to dynamically select the one or more active tasks;
automatically migrating the one or more active tasks to the suspended state;
performing one or more remaining active tasks of the set of active tasks; and
updating the trained machine learning algorithm, wherein the trained machine learning algorithm is updated using the profile corresponding to the member, the cognitive load, and a new cognitive load resulting from migration of the one or more active tasks of the set to the suspended state.

2. The computer-implemented method of claim 1, wherein automatically detecting the indication of the cognitive load change includes:
processing the set of messages using a Natural Language Processing (NLP) algorithm to identify one or more anchor terms, wherein the one or more anchor terms correspond to the cognitive load change.

3. The computer-implemented method of claim 1, further comprising:
updating an active task interface to remove the one or more active tasks migrated to the suspended state.

4. The computer-implemented method of claim 1, further comprising:
detecting completion of the one or more remaining active tasks of the set;
identifying another cognitive load resulting from the completion of the one or more remaining active tasks; and
migrating an active task of the set from the suspended state to an active state, wherein the active task is migrated to the active state based on the other cognitive load.

5. The computer-implemented method of claim 1, further comprising:
dynamically generating one or more prompts for approval to migrate the one or more active tasks to the suspended state, wherein when the one or more prompts are generated, the one or more prompts are provided to obtain the approval.

6. The computer-implemented method of claim 1, further comprising:
transmitting a notification in response to determining that the cognitive load of the member exceeds the threshold, wherein when the notification is received by the representative, the one or more active tasks of the set selected for migration are presented to the representative.

7. The computer-implemented method of claim 1, wherein the one or more active tasks of the set are selected based on a determination that a level of urgency for completion of the selected one or more active tasks is less than other active tasks of the set.

8. A system, comprising:
one or more processors; and
memory storing thereon instructions that, as a result of being executed by the one or more processors, cause the system to:
receive in real-time a set of messages between a member and a representative as the set of messages are being exchanged;
automatically detect an indication of a cognitive load change associated with the member, wherein the indication is automatically detected based on the set of messages;
determine a cognitive load associated with the member, wherein the cognitive load is determined in response to the cognitive load change, and wherein the cognitive load is determined based on a set of active tasks being performed for the member, presentation of the set of active tasks, and the set of messages;
determine that the cognitive load of the member exceeds a threshold;
dynamically select one or more active tasks of the set for migration to a suspended state, wherein the one or more active tasks are selected using a trained machine learning algorithm, and wherein the trained machine learning algorithm uses a profile corresponding to the member, the set of active tasks, and the cognitive load to dynamically select the one or more active tasks;
automatically migrate the one or more active tasks to the suspended state;
perform one or more remaining active tasks of the set of active tasks; and
update the trained machine learning algorithm, wherein the trained machine learning algorithm is updated using the profile corresponding to the member, the cognitive load, and a new cognitive load resulting from migration of the one or more active tasks of the set to the suspended state.

9. The system of claim 8, wherein the instructions that cause the system to automatically detect the indication of the cognitive load change further cause the system to:
process the set of messages using a Natural Language Processing (NLP) algorithm to identify one or more anchor terms, wherein the one or more anchor terms correspond to the cognitive load change.

10. The system of claim 8, wherein the instructions further cause the system to:
update an active task interface to remove the one or more active tasks migrated to the suspended state.

11. The system of claim 8, wherein the instructions further cause the system to:
detect completion of the one or more remaining active tasks of the set;
identify another cognitive load resulting from the completion of the one or more remaining active tasks; and
migrate the one or more active tasks of the set from the suspended state to an active state, wherein the one or more active tasks are migrated to the active state based on the other cognitive load.

12. The system of claim 8, wherein the instructions further cause the system to:
dynamically generate one or more prompts for approval to migrate the one or more active tasks to the suspended state, wherein when the one or more prompts are generated, the one or more prompts are provided to obtain the approval.

13. The system of claim 8, wherein the instructions further cause the system to:
transmit a notification in response to determining that the cognitive load of the member exceeds the threshold, wherein when the notification is received by the representative, the one or more active tasks of the set selected for migration are presented to the representative.

14. The system of claim 8, wherein the one or more active tasks of the set are selected based on a determination that a level of urgency for completion of the one or more active tasks is lower than other active tasks of the set.

15. A non-transitory, computer-readable storage medium storing thereon executable instructions that, as a result of being executed by a computer system, cause the computer system to:
receive in real-time a set of messages between a member and a representative as the set of messages are being exchanged;
automatically detect an indication of a cognitive load change associated with the member, wherein the indication is automatically detected based on the set of messages;
determine a cognitive load associated with the member, wherein the cognitive load is determined in response to the cognitive load change, and wherein the cognitive load is determined based on a set of active tasks being performed for the member, presentation of the set of active tasks, and the set of messages;
determine that the cognitive load of the member exceeds a threshold;
dynamically select one or more active tasks of the set for migration to a suspended state, wherein the one or more active tasks are selected using a trained machine learning algorithm, and wherein the trained machine learning algorithm uses a profile corresponding to the member, the set of active tasks, and the cognitive load to dynamically select the one or more active tasks;
automatically migrate the one or more active tasks to the suspended state;
perform one or more remaining active tasks of the set of active tasks; and
update the trained machine learning algorithm, wherein the trained machine learning algorithm is updated using the profile corresponding to the member, the cognitive load, and a new cognitive load resulting from migration of the one or more active tasks of the set to the suspended state.

16. The non-transitory, computer-readable storage medium of claim 15, wherein the executable instructions that cause the computer system to automatically detect the indication of the cognitive load change further cause the computer system to:
process the set of messages using a Natural Language Processing (NLP) algorithm to identify one or more anchor terms, wherein the one or more anchor terms correspond to the cognitive load change.

17. The non-transitory, computer-readable storage medium of claim 15, wherein the executable instructions further cause the computer system to:
update an active task interface to remove the one or more active tasks migrated to the suspended state.

18. The non-transitory, computer-readable storage medium of claim 15, wherein the executable instructions further cause the computer system to:
detect completion of the one or more remaining active tasks of the set;
identify another cognitive load resulting from the completion of the one or more remaining active tasks; and
migrate the one or more active tasks of the set from the suspended state to an active state, wherein the one or more active tasks are migrated to the active state based on the other cognitive load.

19. The non-transitory, computer-readable storage medium of claim 15, wherein the executable instructions further cause the computer system to:
dynamically generate one or more prompts for approval to migrate the one or more active tasks to the suspended state, wherein when the one or more prompts are generated, the one or more prompts are provided to the member to obtain the approval.

20. The non-transitory, computer-readable storage medium of claim 15, wherein the executable instructions further cause the computer system to:
transmit a notification in response to determining that the cognitive load of the member exceeds the threshold, wherein when the notification is received by the representative, the one or more active tasks of the set selected for migration are presented to the representative.

21. The non-transitory, computer-readable storage medium of claim 15, wherein the one or more active tasks of the set are selected based on a determination that a level of urgency for completion of the one or more active tasks is lower than other active tasks of the set.
